(19) United States
(12) Patent Application Publication
(10) Pub. No.: US 2017/0238769 A1
(43) Pub. Date: Aug. 24, 2017

(54) Bathing Wand

(71) Applicant: Michael Graves Design Group, Inc., Princeton, NJ (US)

(72) Inventors: Robert B. Van Varick, Princeton, NJ (US); Donald S. Strum, Princeton, NJ (US); Michael E. Graves, Princeton, NJ (US); Vladimir I. Anokhin, Princeton, NJ (US); Jessica L. Hurwit, Princeton, NJ (US); Elizabeth W. Clubb, Atlanta, GA (US); Michael A. Daley, US, WI (US); Bryan J. Semkuley, Roswell, GA (US); Clarice M. Theisen, Roswell, GA (US); Lynn R. Healey, Neenah, WI (US); Melissa Dennis, Neenah, WI (US); Eric E. Butt, Milford, CT (US); Adam I. Lehman, Milford, CT (US); Jeffrey Randsen, Milford, CT (US); James A. Walter, Neenah, WI (US); James D. McManus, Roswell, GA (US); Randal D. Olson, Neenah, WI (US); Aidan J. Petrie, Providence, RI (US); Luke D. Hagan, Providence, RI (US); Benoit Devinat, Providence, RI (US); Daniel J. Nelsen, Providence, RI (US); Peiguang Zhou, Neenah, RI (US); Davis Dang H. Nhan, Neenah, WI (US)

(73) Assignee: Michael Graves Design Group, Inc., Princeton, NJ (US)

(21) Appl. No.: 15/519,281

(22) PCT Filed: Oct. 15, 2015
(86) PCT No.: PCT/US2015/055753

§ 371 Date: Apr. 14, 2017

Related U.S. Application Data
(60) Provisional application No. 62/064,322, filed on Oct. 15, 2014.
(60) Provisional application No. 62/234,767, filed on Sep. 30, 2015.

(51) Int. Cl. A47K 7/02; B25G 1/02; B25G 1/10

(52) U.S. Cl. CPC A47K 7/028; B25G 1/102; B25G 1/02

(57) ABSTRACT

A bathing wand (10) can include a handle (24) including a grasp (20). The grasp (20) can include a first section (34) and a second section (36). The first section (34) and the second section (36) can form a loop hole (38) configured to receive a user's hand. The bathing wand (10) can also include a wand head (12) and a bathing implement (16). The bathing implement (16) can be coupled to the wand head (12). In some configurations, the bathing wand (10) can include a vertebrae system (30).

### TECHNICAL FIELD

The present disclosure relates to an apparatus to facilitate bathing. More particularly, the present disclosure relates to a bathing wand which can operate with a plurality of interchangeable and selectively removable cleaning heads which can be utilized with a handle or with just the hand.

### BACKGROUND OF THE DISCLOSURE

It has been found that various bathing wand assemblies are provided that enhance the bathing experience. The most common assembly is a straight and rigid handle with a brush, pouf or loofah on one end. However, the straight handle can make it difficult to reach the back if one's mobility is limited. Typically it only has one accessory which is rigidly attached to the bathing handle. This prevents the user from selecting a desired cleaning head which meets their cleaning needs or preference. Additionally, it means that once the cleaning head is soiled or used, the handle may no longer be effectively utilized. In response to the need for an improved device reach to the back, the market has provided a jointed handle that can bend at one or more angles. However, many such devices require screws and are not practical for adjustment with wet soapy hands.

Another drawback to prior art bathing wands is that the portion of the handle meant for grasping is a rigid plastic or wood. It can be difficult to keep a grasp on such a handle with wet soapy hands, especially if one has arthritis or other hand problems.

A further drawback to prior art bathing wands that include a pouf made of gathered mesh material is that the pouf can have an internal attachment mechanism such as a staple that holds the gathering. However, with enough pressure that staple can be felt against the skin, and perhaps even scratch the skin.

Accordingly, there exists a need for an improved bathing wand that is adjustable and comfortable and easy to use. There also exists the need for a bathing wand with a pouf that is constructed without staples. A need exists for the user to be able to choose the type of cleaning accessory which best meets their cleaning needs and preferences. Furthermore, it is of practical benefit to the user to be able to easily replace the cleaning accessory once it is no longer of service without disposing of the bathing wand. Additionally, it is desirable to have a cleaning wand which can be used with or without a handle to effectively clean the body, particularly for individuals with limited dexterity and mobility.

### SUMMARY OF THE DISCLOSURE

The present disclosure is directed to a multi-function bathing wand. In one embodiment, a bathing wand can include a handle including a grasp. The grasp can include a first section and a second section. The first section and the second section can form a loop hole configured to receive a user's hand. The bathing wand can also include a wand head. The bathing wand can further include a bathing implement. The bathing implement can be coupled to the wand head.

In another embodiment, a bathing wand can include a handle including an arm. The arm can include a vertebrae system that includes a plurality of links coupled together. The vertebrae system can allow the arm to bend. The bathing wand can also include a wand head. The bathing wand can further include a bathing implement. The bathing implement can be coupled to the wand head.

In yet another embodiment, a bathing wand can include a handle including an arm. The handle can further include a grasp on a first end of the arm and a neck on a second end of the arm. The neck can include one of a raised feature and an aperture. The bathing wand can further include a wand head. The wand head can include a receiver configured to be removably coupled to the handle by the receiver receiving the neck of the handle. The receiver can include the other of a raised feature and an aperture. The raised feature can be configured to fit in the aperture to removably couple the wand head to the handle. The bathing wand can further include a bathing implement. The bathing implement can be coupled to the wand head.

### BRIEF DESCRIPTION OF DRAWINGS

Various embodiments of the present invention will be disclosed, by way of example, in reference to the following drawings in which:

FIG. 1A is an side view of a bathing wand handle and head according to the present disclosure;

FIG. 1B is a cross-section view of the wand handle of FIG. 1A;

FIG. 2 is an exploded view of the wand handle shown in FIG. 1A;

FIGS. 3A and 3B is a closer view of the male/female connection between the wand handle and head;

FIG. 4 is a top plan view of the wand head of FIG. 1A;

FIG. 5A is a top isometric view of a cleaning cloth embodiment of the bathing wand of the present disclosure in an assembled state;

FIG. 5B is the bathing wand of FIG. 5A showing the cloth implement separated from the neck of the wand handle;

FIG. 5C is a top isometric view of with cloth implement being used separate from the wand handle;

FIG. 5D is an isometric view of the cloth implement of FIG. 5C;

FIG. 6A is an isometric view of the cloth implement of FIG. 5D;

FIG. 6B is a top view of the cloth implement of FIG. 5A;

FIG. 6C is a back view of the cloth implement of FIG. 5A;

FIG. 6D is a side view of the cloth implement of FIG. 5A;

FIG. 6E is a section view of the wand head of FIG. 4

FIG. 7 is an isometric view of sponge implement of the bathing wand of the present disclosure;

FIG. 8 is a top isometric view of pouf implement of the bathing wand of the present disclosure;

FIG. 9A is a top view of pouf implement of FIG. 8;

FIG. 9B is a side view of pouf implement of FIG. 8;

FIG. 10 is a view of the pouf implement of FIG. 8;

FIG. 11 is an internal rib member supporting the pouf mesh according to the present disclosure;

FIG. 12A is a plan view of the rib member of FIG. 11;

FIG. 12B is a top view of the pouf of FIG. 10;

FIG. 13 is a schematic view of a mesh ribbon fold pattern according to the present disclosure;

FIG. 14 is a schematic view of the stitching of the ribbon fold of FIG. 13;

FIG. 15A is an isometric view of an alternative sponge implement;

FIG. 15B is a top view of the sponge implement of FIG. 15A;

FIG. 15C is a back view of the sponge implement of FIG. 15A;

FIG. 15D is a side view of the sponge implement of FIG. 15A;

FIGS. 16-39 are various alternative head attachment designs;

FIGS. 40-46 are various alternative handles;

FIGS. 47-51 are various alternative bending mechanisms;

FIG. 52 is an infrared spectra plot of G7950 polymer sheet (set 3) Side A. (Top to Bottom) Edge at room temperature, Edge at 60° C. for 6 days, Middle at room temperature and Middle at 60° C. for 6 days;

FIG. 53 is an infrared spectra plot of G7950 polymer sheet (set 3) Side B. (Top to Bottom) Edge at room temperature, Edge at 60° C. for 6 days, Middle at room temperature and Middle at 60° C. for 6 days;

FIG. 54 is an infrared spectra plot of G7950 polymer sheet+20% EVA copolymer (set 3) Side A. (Top to Bottom) Edge at room temperature, Edge at 60° C. for 72 hrs, Middle at RT and Middle at 60° C. for 72 hrs; and

FIG. 55 is an infrared spectra plot of G7950 polymer sheet+20% EVA copolymer (set 3) Side B. (Top to Bottom) Edge at room temperature, Edge at 60° C. for 72 hrs, Middle at RT and Middle at 60° C. for 72 hrs.

Repeat use of reference characters in the present specification and drawings is intended to represent the same or analogous features or elements of the disclosure.

### DETAILED DESCRIPTION OF THE DISCLOSURE

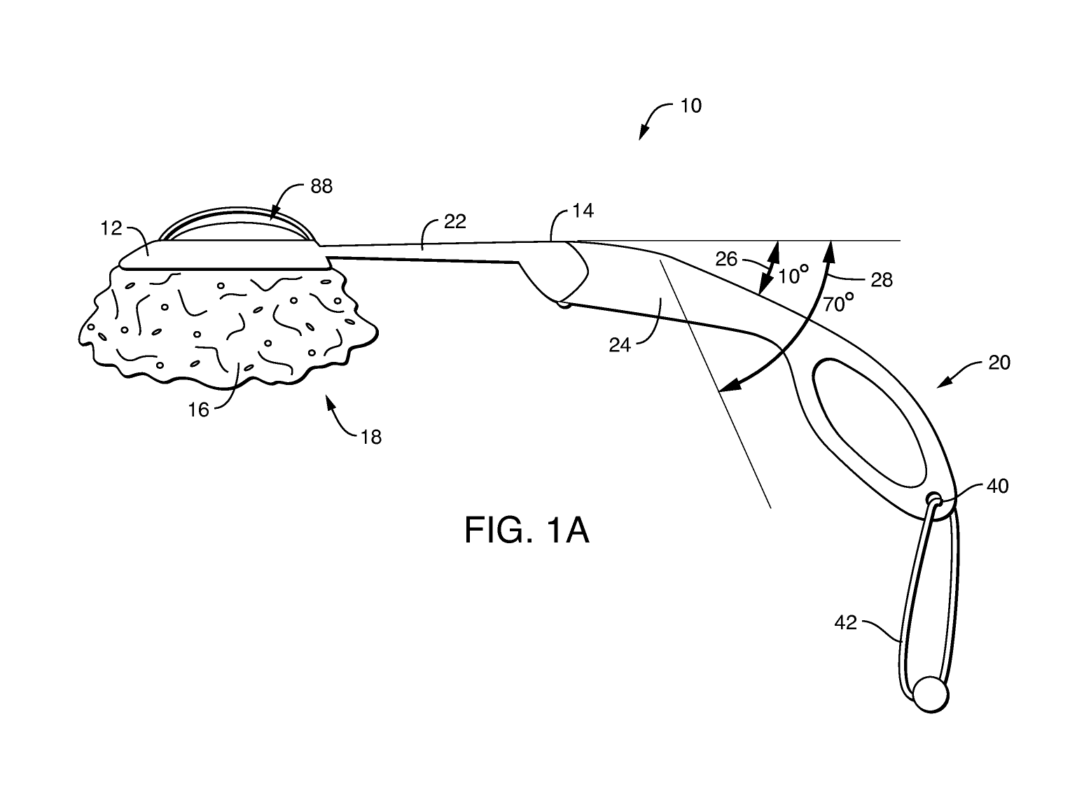

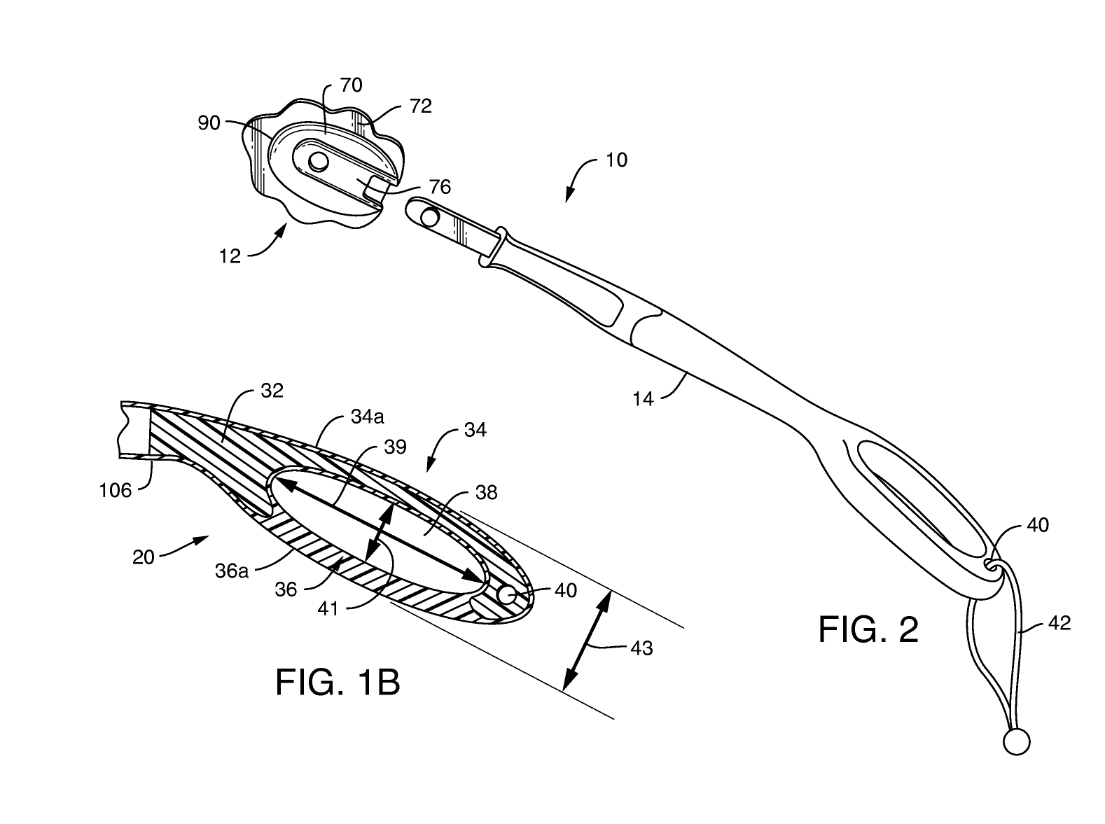

The present disclosure is a multi-functional, modifiable bathing wand to assist an individual in bathing. Referring to FIG. 1A, the bathing wand 10 generally has a wand head 12 to which various bathing implements 16 may be attached, and a wand handle 14. In some embodiments, the wand head 12 can be coupled to the handle 14. It is also contemplated that the wand head 12 can be integral to the handle 14. The bathing implement 16 can be coupled to the wand head 12. The combination of a wand head 12 and a bathing implement 16, i.e. sponge, cloth, or pouf, is generally referred to as a “bathing member 18.” The user can select from the variety of the bathing members 18 described herein, or any other suitable bathing member 18 known to one of skill in the art.

### Wand Handle

Referring to FIG. 1A, there is the wand handle 14 that includes a grasp 20 connected to one end of an arm 24. Extending from the opposite end of arm 24 is a neck 22. In one aspect, handle 14 can optionally articulate so that the neck 22 can be bent anywhere from about a straight position to about a 90 degree maximum angle 28. In a preferred embodiment, the handle 14 can articulate so that the neck 22 can be bent from about a 10 degree angle 26 from the straight position to about a 70 degree maximum angle 28, as illustrated in FIG. 1A. The user can determine what angle to select to suit their particular bathing need by simply holding grasp 20 and attached bathing member 18, and bending the arm 24. Other particular points or mechanisms for grasping the bathing stick may also be utilized for the user to achieve the proper amount of bend in the bathing wand. This particular range allows the user a range of positions to effectively bathe and cleanse themselves. For example, a user may bend the wand horizontally to allow them to effectively clean their legs and feet. Alternatively, the user may bend the wand a total of about 70 degrees from horizontal to allow them to easily bathe and cleanse their back. The bathing wand handle is easy for the user to bend and achieve the desired angle of bend. This is particularly true for even users with limited body strength. Once it is bent, the bathing wand handle can maintain that shape through-out washing and will not accidentally move from position. Throughout its use the bathing wand can be bent multiple times at will. An optional wrist lanyard 42 may be attached to end of grasp 20 at aperture 40.

Referring to FIG. 1B, the grasp 20 can have two main sections, a first section 34 and a second section 36. The first section 34 can form an upper portion of the grasp 20 and the second section 36 can form a lower portion of the grasp 20. The first section 34 and the second section 36 can form a loop hole 38 configured to receive a user's hand. The sizing of the grasp 20 and loop hole 38 can be very important to the proper functioning and multiple handle grips/uses of the grasp 20 for a user and were selectively configured. The first section 34 and the second section 36 can be separate from one another and coupled together as will be discussed in some preferred embodiments below. Alternatively, the first section 34 and the second section 36 can form the same component but refer to different locations of the grasp 20.

The loop hole 38 can be configured such that it has a length 39 and a height 41. In some embodiments, the loop holes 38 can have a length 39 between about 80 mm and about 130 mm. In more preferred embodiments, the length 39 can be between about 95 mm and about 115 mm. For purposes herein, the length 39 of the loop hole 38 is measured as a greatest length of the loop hole 38 when the grasp 20 or loop hole 38 is not being altered by a hand of the user. For example, when the loop hole 38 is in the shape of an ellipse, such as illustrated in FIG. 1B, the length 39 of the loop hole 38 can be a major axis of the loop hole 38.

The loop hole 38 can be configured such that it has a height 41 of between about 15 mm and about 50 mm. In preferred embodiments, the height 41 can be between about 20 mm and about 35 mm. For purposes herein, the height 41 of the loop hole 38 is measured as a greatest height of the loop hole 38 when the grasp 20 or loop hole 38 is not being altered by a hand of the user. For example, when the loop hole 38 is in the shape of an ellipse, such as illustrated in FIG. 1B, the height 41 of the loop hole 38 can be a minor axis of the loop hole 38.

The grasp 20 can have a height 43 defined by an outer surface 34a of the first section 34 and an outer surface 36a of the second section 36. The height 43 of the grasp 20 can be between about 30 mm and about 70 mm. In preferred embodiments, the height 43 of the grasp 20 can be between about 40 mm and about 60 mm. For purposes herein, the height 43 of the grasp 20 is measured as a greatest distance between the outer surface 34a of the first section 34 and an outer surface 36a of the second section 36, as measured in a direction parallel to the height 41 of the loop hole 38, as illustrated in FIG. 1B.

In some embodiments, the grasp 20 can be configured to provide flexibility for fitting the hand of a user and providing enhanced gripping ability. For example, the first section 34 can comprise a more rigid material than the second section 36. Likewise, the second section 36 can comprise a more flexible material than the first section 34. For example, the first section 34 can provide a rigid section and the second section 36 can provide a pliable section for the grasp 20.

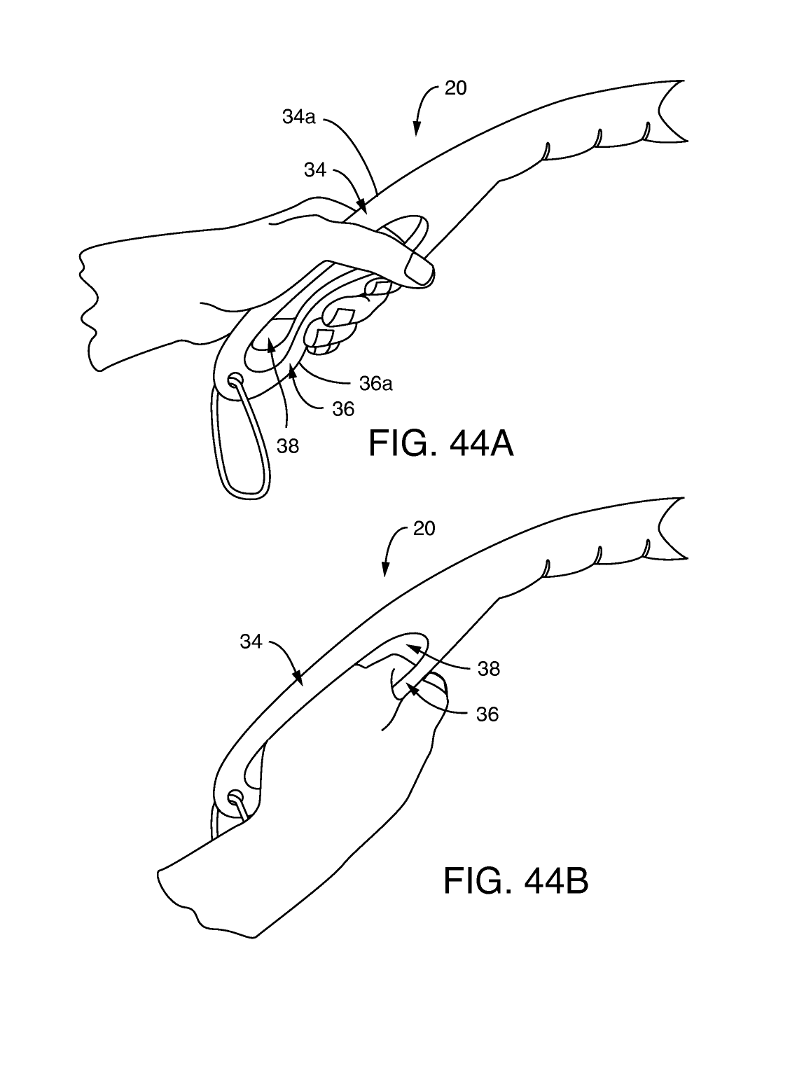

As illustrated in FIGS. 44A and 44B, the selectively configured grasp 20 and loop hole 38 can provide numerous, comfortable orientations for a user to grip and control the bathing wand 10. For example, FIG. 44A illustrates a user gripping the grasp 20 by gripping on the outer surface 34a of the first section 34 and the outer surface 36a of the second section 36. Where the second section 36 is comprised of a pliable material, the second section 36 provides for the user to be able to comfortably flex the second section 36 of the grasp 20 and provide a springy feel. In such an embodiment, the pliable section can be provided on a bottom side of the grasp 20.

FIG. 44B illustrates a user employing an alternative grip. In FIG. 44B, the user is gripping the grasp 20 by placing their fingers through the loop hole 38 and wrapping them around the second section 36 of the grasp 20. Due to the selective configuration of the dimensions and aspect ratio of the length 39 and height 41 of the loop hole 38 (both labeled in FIG. 1B), the loop hole 38 can provide a snug fit for the user's hand, thus providing an alternative arrangement for controlling the bathing wand 10.

Other alternative grips for the grasp 20 not shown, but facilitated by the selectively configured loop hole 38 and grasp 20, include a user inserting their fingers through the loop hole 38 and wrapping them around the first section 34, or even just inserting their fingers through the loop hole 38 and allowing the friction between their fingers and/or hand and the first section 34 and second section 36 to allow them to control the bathing wand 10. The latter example may be particularly desired for an individual who has arthritis and has lost dexterity in their hands.

In some embodiments, the neck 22 can be made from a rigid plastic such as polypropylene, and can be formed by injection molding or the like. In preferred embodiments, the arm 24 and grasp 20 can have a flexible overmold 106 that is co-molded with a rigid substrate 32, as shown in FIG. 1B. In some embodiments, a portion of the rigid substrate 32 and the flexible overmold 106 can form the first section 34 of the grasp 20, described above. In some embodiments, the flexible overmold 106 can form the entire second section 36 of the grasp 20. The flexible overmold 106 in both the first section 34 and the second section 36 can provide enhance gripping and control for a user in all of the potential gripping positions as described above.

The overmold material 106 can be produced from rubbers, elastomers, polymers, plastomers and other flexible materials. One characteristic of the overmold material is that it is lightweight and moldable to the substrate, and has adequate tear strength. These characteristics provide an overmold that is durable while also being comfortable to the consumer. Another possible characteristic is that the overmold material is not overly slick when wet to prevent a user from accidentally dropping the bathing wand. To this effect, texture may be added to the outside surface of the overmold material to provide a more grippable surface. Several categories of overmold materials may be considered by those skilled in the art. For example, thermoplastic elastomers such as TPEs or curable silicone rubber may be used as an overmold material. Such materials are thermoplastic with ease to process and good colorability. They are also recyclable leading to low waste during production and the opportunity for post-consumer use. Such materials display adequate chemical resistance and bondability to a number of substrates at a relatively low cost. Suitable TPE materials include styrenic block copolymer TPEs (such as KRATON G SEBS, thermoplastic polyurethanes (TPU) and olfeinic TPEs, and polyolefin blends (TPO). In one aspect, the overmold material is DYNAFLEX G7950-1 which may be obtained from PolyOne Corporation. Suitable curable silicone overmold materials include cured polysiloxane. This material is non-reactive, stable and resistant to extreme environments, and is easy to manufacture and shape with low shrinkage and low compression set. It is noted that curable silicones have more arduous process conditions than TPEs. Further, they are a thermoset material with no opportunity for recyclability. Suitable curable silicone materials include SILASTIC EHJ50POO 1-part PT rapid cure compound from Dow Corning; SILASTIC SMOOTH-SIL 950 Pt cure silicone (SMOOTH-ON) and NJB TC-5050 RTC Pt. from Chembar.

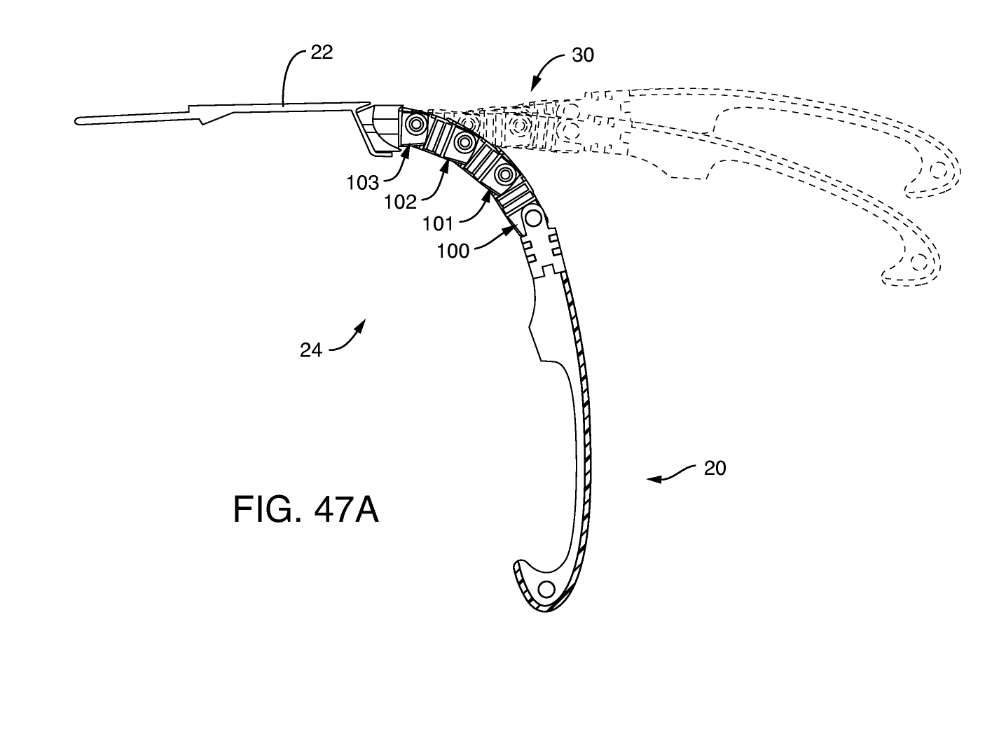

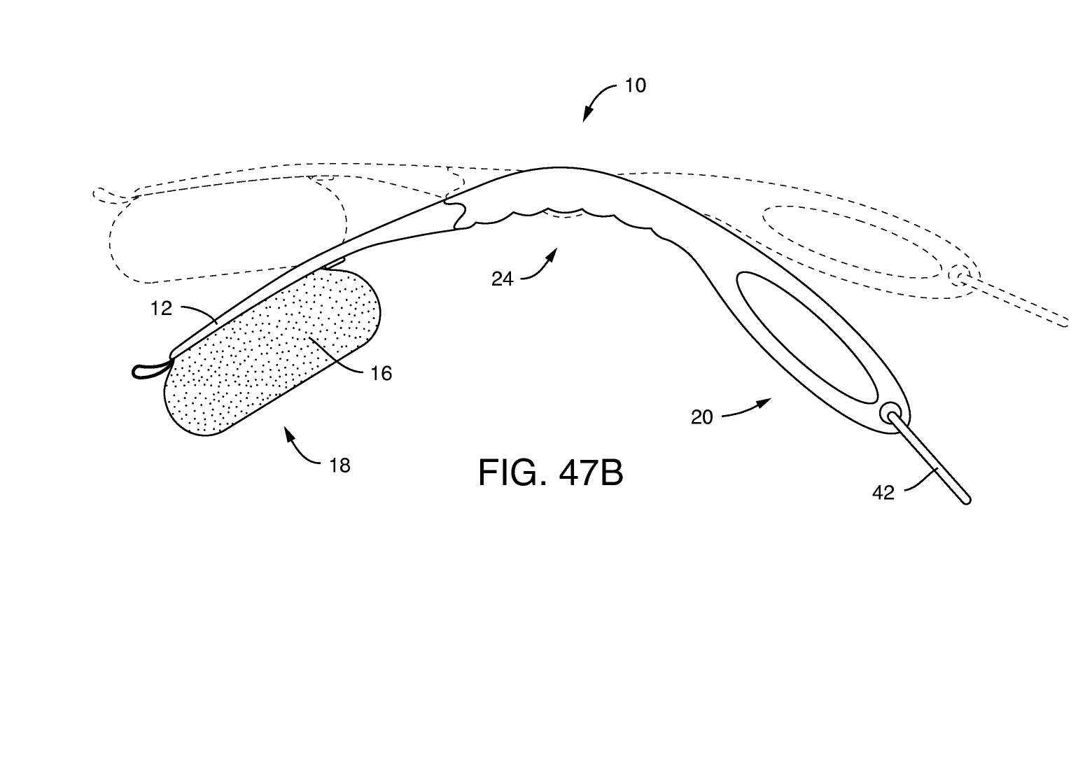

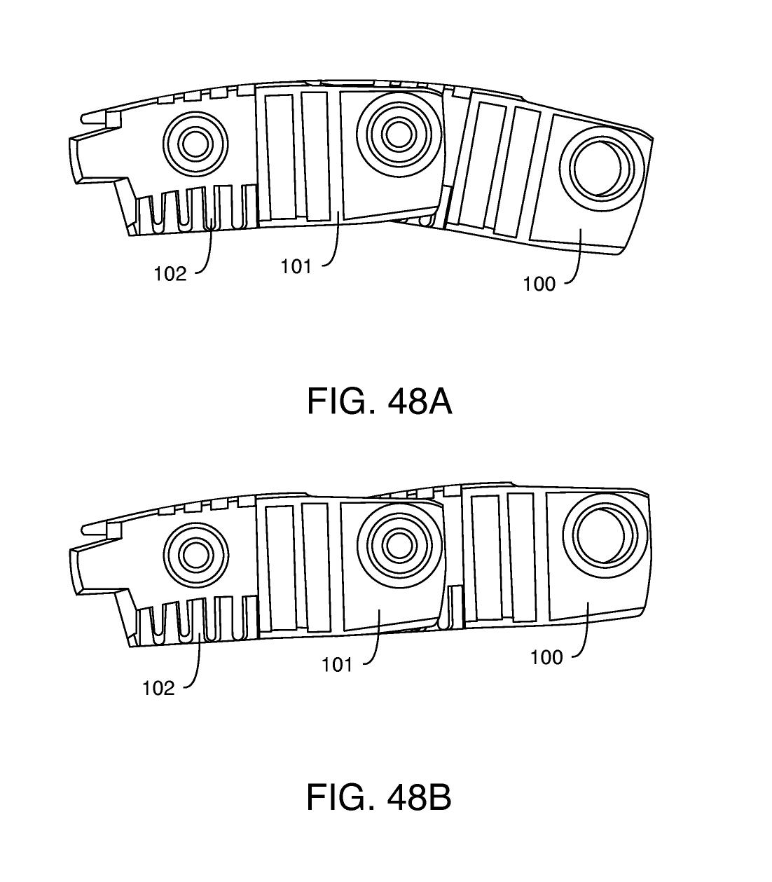

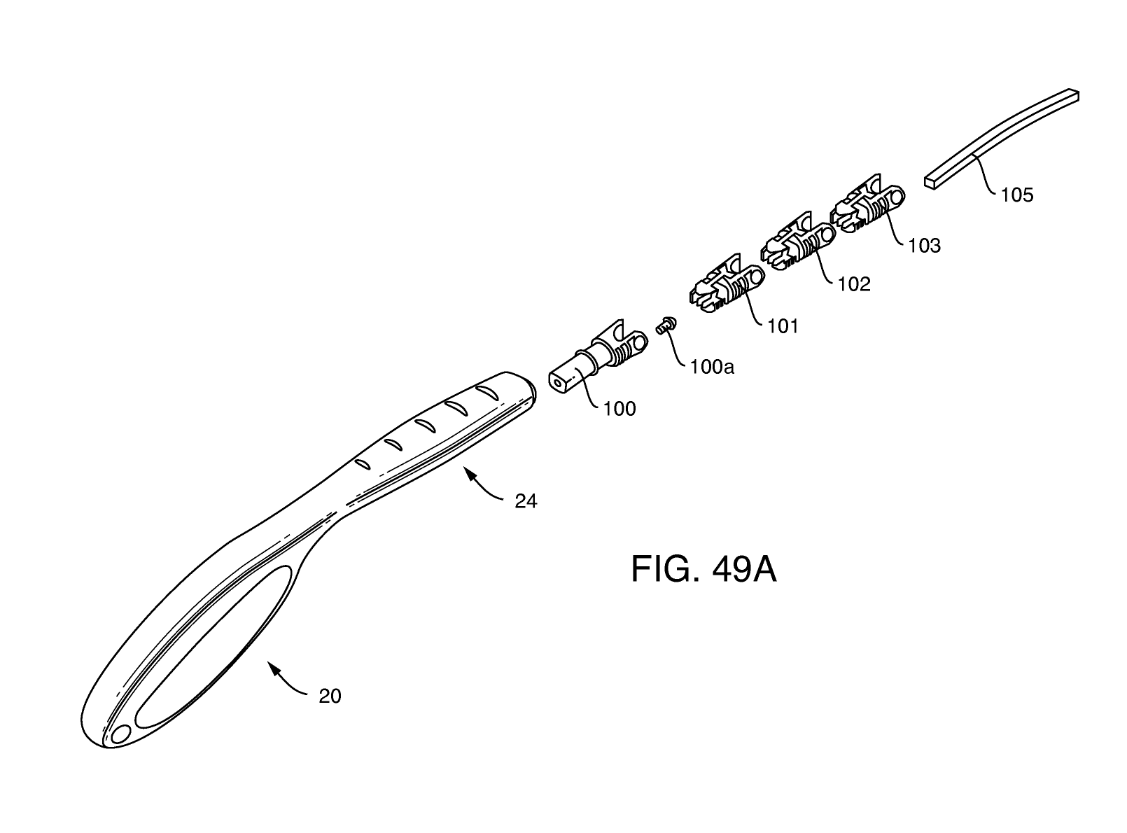

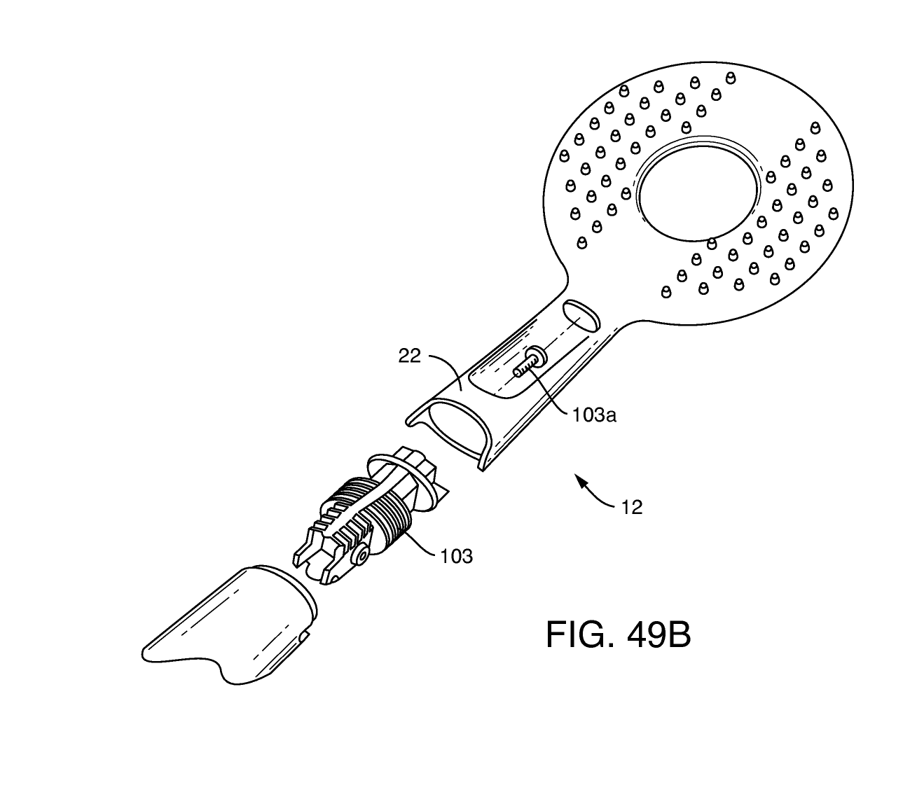

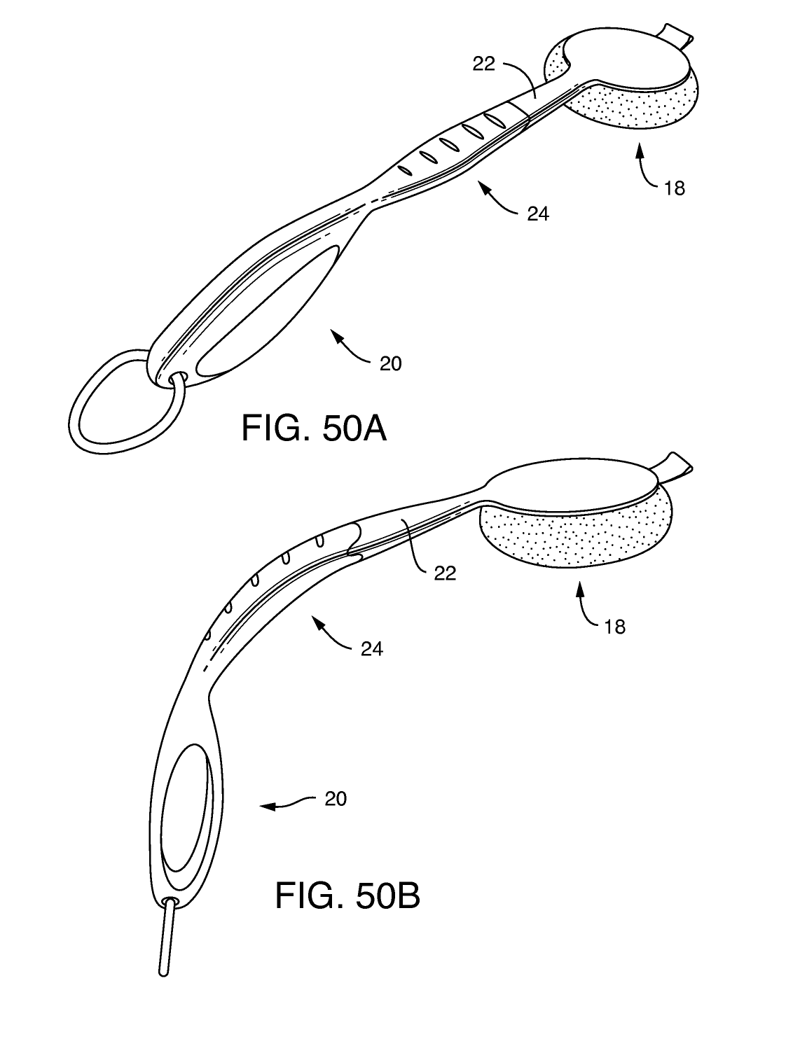

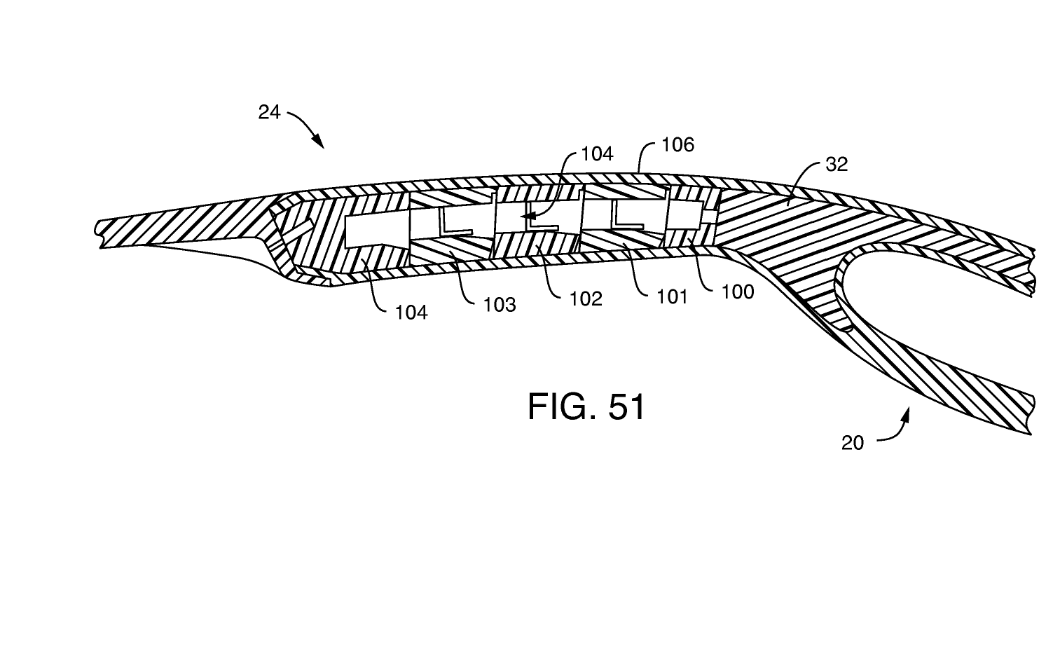

In some embodiments, the bathing wand can include an arm 24 that includes a vertebrae system 30. The vertebrae system 30 can be internal to the arm 24. The vertebrae system 30 can be located between the grasp 20 and the neck 22 of the arm 24. The vertebrae system 30 can allow the arm 24 to bend, as illustrated in FIGS. 47A, 47B, 50A, and 50B. FIG. 47A illustrates a cross-sectional view providing an image of the vertebrae system 30. The vertebrae system 30 can include a plurality of links 100, 101, 102, 103 coupled together. In some embodiments, there may be four links 100, 101, 102, 103, such as illustrated in FIG. 47A. FIGS. 48A and 48B illustrate how some of the links 100, 101, 102 can be coupled together and how one link 30 of the vertebrae system 30 can bend with respect to the others. For example, in FIG. 48A, there is a bending angle between link 100 and link 101. In some embodiments, there may be five or more links 100, 101, 102, 103, 104, such as illustrated in FIG. 51. As illustrated in FIGS. 49A and 51, the proximal link 100 can be coupled to a handle substrate 32 near a first end of the arm 24. The proximal link 100 can be coupled to the handle substrate 32 with a fastener, such as a screw 100a, as shown in FIG. 49A.

The proximal link 100 can be attached to a rear link 101. In some embodiments, the rear link 101 can be attached to one or more mid-links (mid-link 102 in FIGS. 47A and 49A, mid-links 102, 103 in FIG. 51). The last mid-link (mid-link 102 in FIG. 47A, mid-link 103 in FIG. 51) can be attached to a distal link (103 in FIG. 49A, 104 in FIG. 51). The distal link 103 (FIG. 49A) or 104 (FIG. 51) can be rigidly attached to the wand neck 22, for example, with the use of a fastener, such as a screw 103a, as shown in FIG. 49B. It is important to note that while these specific links have been designed for this bathing wand 10 that adaptions to the number, size, orientation and configuration of links in a bathing wand vertebrae system 30 have been anticipated and understood as to their broader applicability within this application and others.

Referring now to FIGS. 49A and 51, the vertebrae system 30 can include a channel 104. The channel 104 can extend from the proximal link 100 to the distal link 103 or 104. The vertebrae system 30 can also include a spine 150, as illustrated in the exploded view of FIG. 49A. The spine 105 can be disposed within the channel 104. The spine 105 can provide the flexural and bending characteristics and also the structural rigidity for the vertebrae system 30.

The links 100, 101, 102, 103, 104 etc. of the vertebrae system 30 are produced from plastics, although it is also understood that they could be made with metal or ceramics. One suitable plastic material that can provide good results and performance characteristics is acetal. Acetal may provide good strength characteristics while also providing the lubricity necessary for the components to rotating about relative to one another. One particular type of acetal which has shown strong performance characteristics is DELRIN which may be obtained from DuPont.

The continuous member or spine 105 may be prepared from plastics, metals ceramics or combinations of materials within those classes. In one aspect, the spine 105 is produced from an aluminum alloy. In one aspect, a suitable aluminum alloy is 1050-o. This particular material has the characteristics of providing ease of bending the handle 14 while also holding its intended shape once the handle 14 is bent.

It is important to note that in some preferred embodiments, the entire bathing wand 10 handle 14 is enclosed or encapsulated with a plastic, rubber or elastic overmold 106. The overmold 106 and its method of attachment and assembly to the rigid handle substrate 32 and the wand neck 22 render the bathing wand 10 to be waterproof and tight. This prevents water from entering the bathing wand 10 such that it would increase the product weight or create a sloshing sound that would be negative to the experience of the user. It also prevents water from entering and standing in the device such that it could harbor microorganisms such as mold or bacteria. In addition to potential risk of sickness from creating a germ harbor, the production of these conditions could create mal-odor or in the case of mold black colored water. Both of these would be counter to the bathing experience which is being targeted for this bathing wand 10. This overmold 106 is especially important for protecting the vertebrae system 30 described above.

The various materials from which the bathing wand 10 handle 14 and its components are constructed is varied based on their application and desired function. In its broadest sense, these components may be constructed from materials which fall into the broad classes of polymers, plastics, ceramics, metals, rubbers and elastomers. In particular, the combination of materials from within these classes may provide the requisite properties and performance. Furthermore, composites of the various classes of materials are understood by one skilled in the art.

The neck 22 material and the rigid substrate 32 material may be produced from metals, ceramics, plastics, polymers, composites or combinations of those classes of materials. These materials may provide components that are relatively strong, lightweight, and rigid. In one aspect, the neck 22 and rigid substrate 32 may be produced from polypropylene, but it is contemplated that these components could be manufactured from PC, ABS or other materials.

### Wand Head

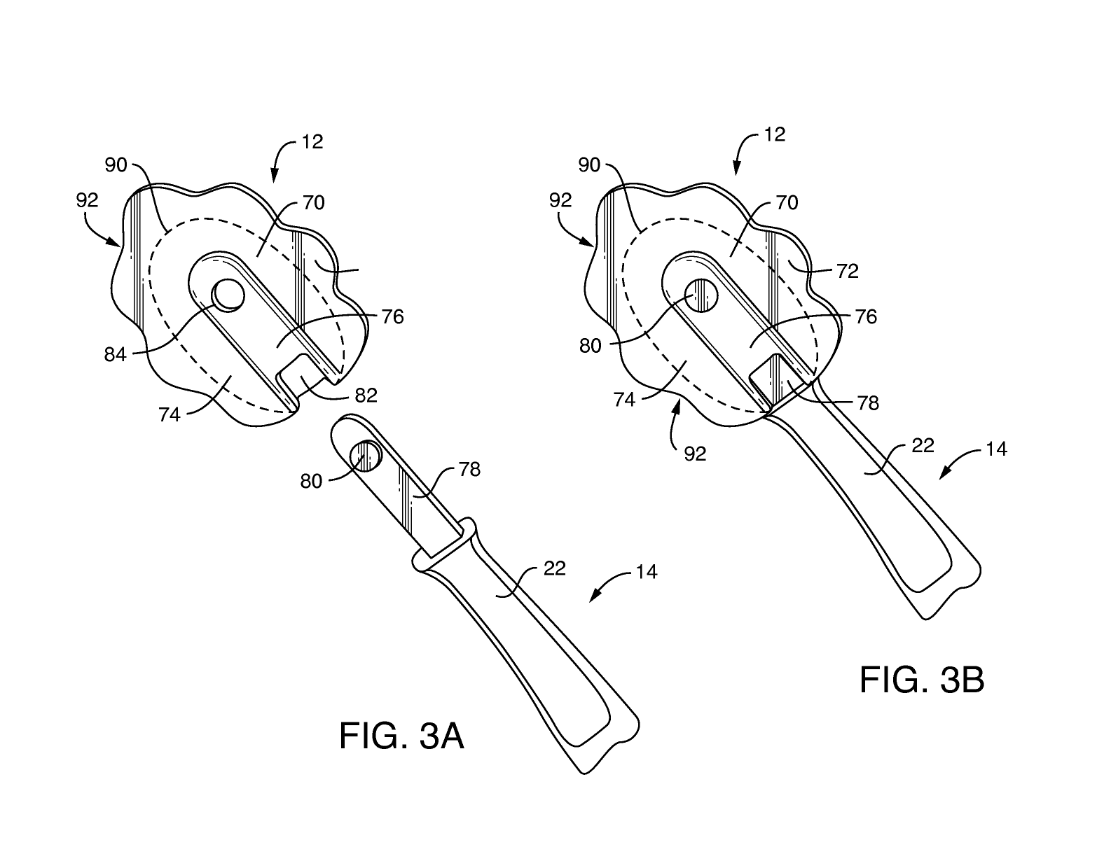

Referring now to FIGS. 3A, 3B, 4 and 6E, the wand head 12 generally has a round or oval domed-section 70 mostly surrounded by a skirt 72. On the underside 74 of the dome 70 is a receiver 76 that is configured to selectively receive the wand handle 14, see FIGS. 3A, 3B. Generally, a stem 78 is inserted to an open end 82 of the receiver 76. The stem 78 is a narrowed end of neck 22. A raised feature 80 fits into an aperture 84. As shown, the raised feature 80 is domed shaped but it contemplated that other shapes may be used. The stem 78 is rigid and allows a user to remove or withdraw the stem 78 from the aperture 84 by applying a minimum force by hand. This allows the raised feature 80 to be effectively removed from the aperture 84 and the stem 78 out of the receiver 76. This system was designed such that the force for removal of stem 78 from receiver 76 as the raised feature 80 is in aperture 84 may be achieved by an elderly user with less physical capability. At the same time, when the raised feature 80 is within the aperture 84, the bathing wand handle and head do not become accidentally disengaged during normal usage. Importantly, while the raised feature 80 is depicted to be on the neck 22 and the aperture 84 is depicted to be in the receiver 76 on the wand head 12, it is contemplated that the raised feature 80 could be in the receiver 76 on the wand head 12 and the aperture 84 could be on the neck 22.

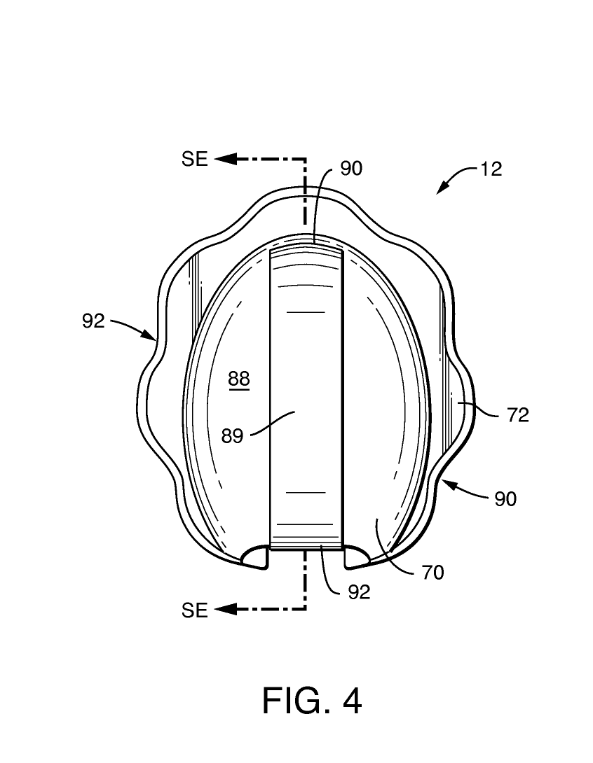

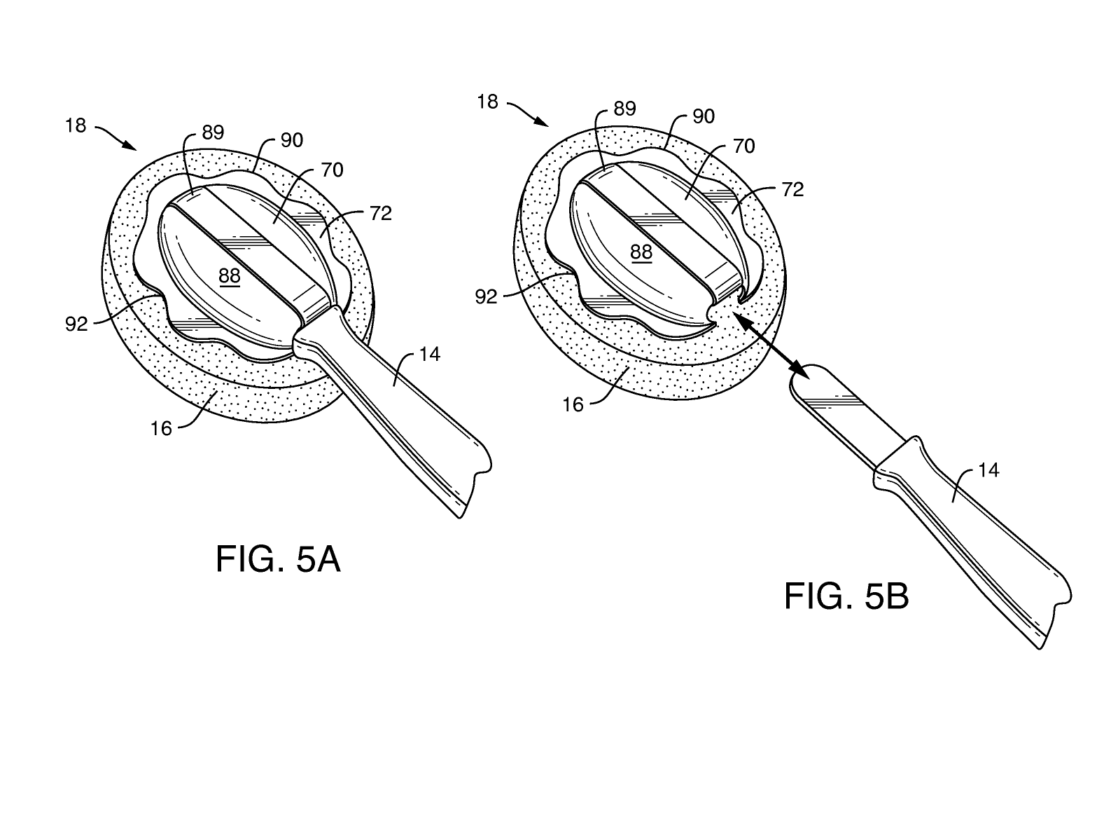

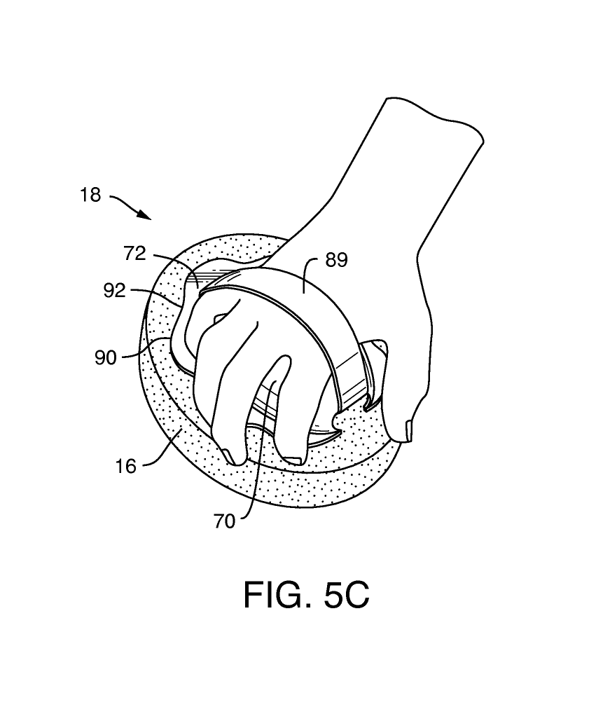

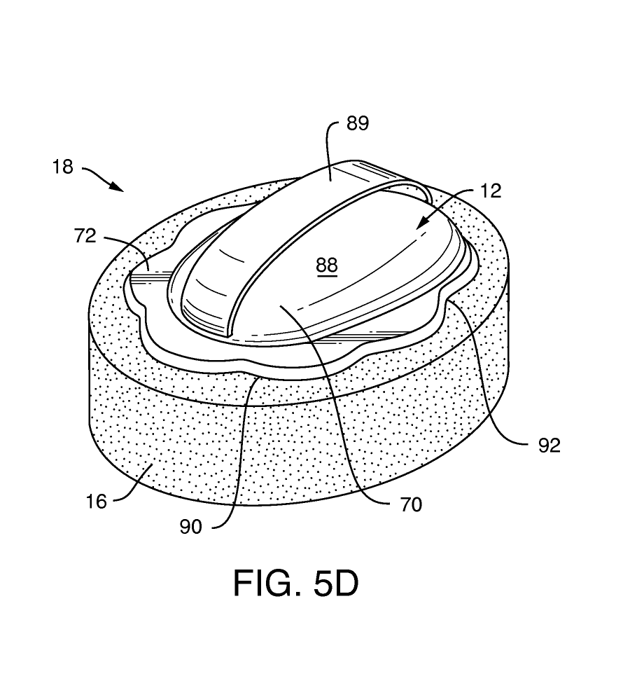

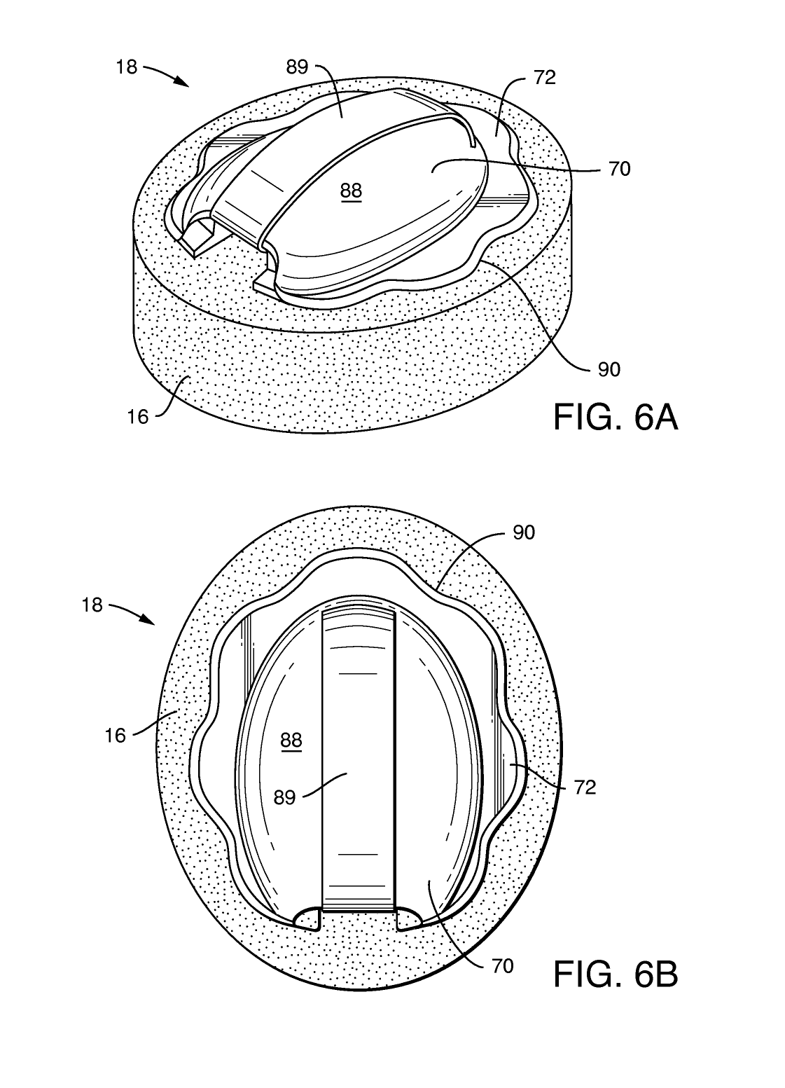

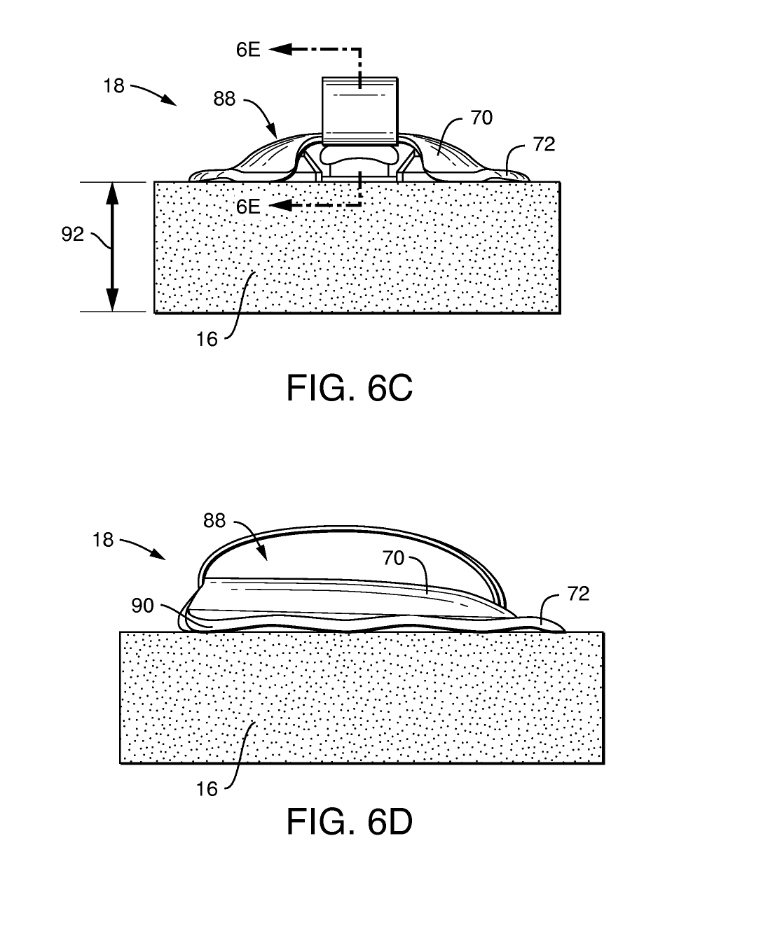

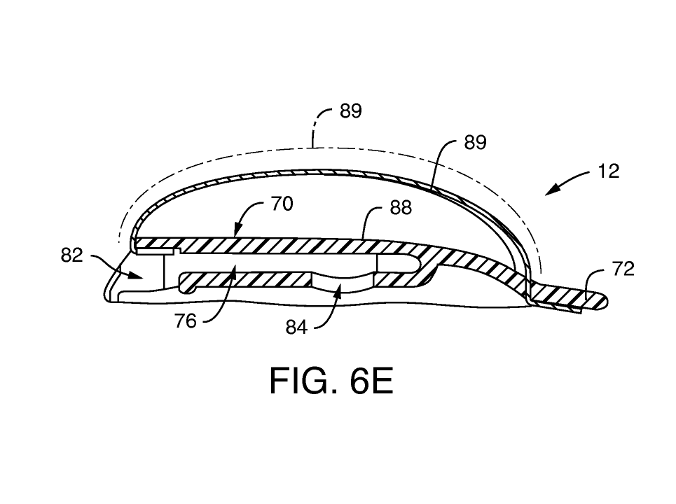

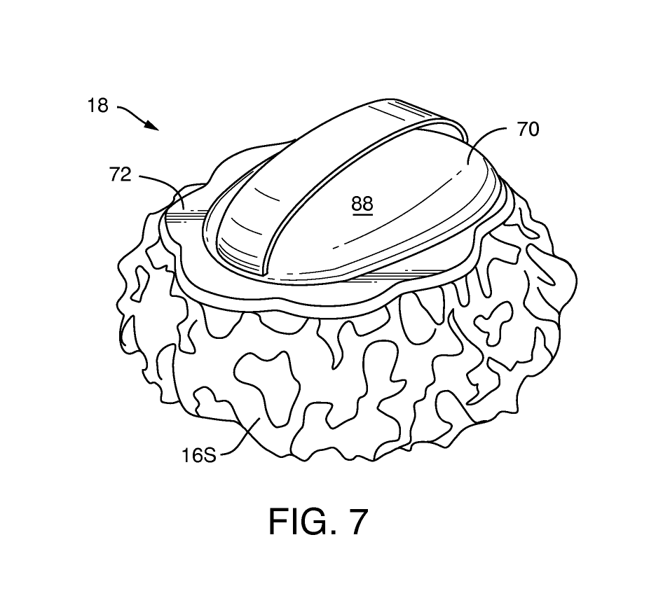

As illustrated on FIGS. 4-5C, on the top surface 88 of the wand head 12 is a strap 89. The strap 89 provides a convenient location through which one may place their hand, see FIG. 5C. The bathing wand 10 can be utilized by a user by removing the wand head 12 as shown in FIG. 5B, and inserting their hand between the strap 89 and the top surface 88 of the wand head 12 and using the wand head 12 and bathing implement 16 separate from the handle 14 of the bathing wand 10. As illustrated in FIG. 6E, the strap 89 can be elastic in nature, such that it can expand to provide a tighter fit to a user's hand. Optionally, the skirt 72 may have an undulating outer edge 90. The undulating outer edge 90 provides increased gripping opportunities when using the wand head 12 as described above, in that one's fingers may fit into each valley 92 of the undulating edge 90 as desired. This is a more comfortable interface than a smooth edge and provides more control for a user.

Because of the mechanism for switching bathing wand heads 12, the user can easily switch different bathing wand heads 12 depending on their preference or bathing need.

### Bathing Members

Referring to FIGS. 5A-D, a bathing wand handle 14 is releasably connected to a bathing member 18. The form of bathing member 18 will vary depending on which bathing implement 16 is attached to head 12. While various embodiments of bathing implements 16 are described herein, it is contemplated that various other suitable bathing implements 16 could be used with the bathing wand 10. As an example, the embodiment of the bathing implement 16 of FIGS. 5A-6D is a cloth-covered foam. Suitable cloths include terry cloth, velour, or other cloths having a nap or nubbed surface as they hold soap better than a smooth cloth. Suitable foams (not shown) include a foam core or other depressible material that can conform to the shape of the user's body. Such foams include a synthetic foam or natural sponges. While the appearance of the natural sponge is appealing to the user, it is not as durable as a synthetic foam and is more costly.

As seen in FIGS. 6A-6E, the bathing member 18 of FIGS. 5A-5D is shown in more detail. The footprint of the bathing implement 16 can be larger than that of the head 12. For example, the implement 16 may extend beyond the edge of the skirt 72 by approximately 1 cm. The thickness 92 (FIG. 6C) is adequate enough that the user does not feel the head structure against their body during use. This can be standard to all the implement 16 embodiments. Of course, the footprint of the bathing implement 16 can be approximately the same size as that of the head 12, or smaller than that of the head 12 in some embodiments.

The cloth implement 16 may be attached to head 12 with an adhesive. It may be desirable to optionally cover the head 12 with a thin material such as vinyl. The entire head 12 may be stitched around the perimeter of skirt 72. The stitching may also extend through to the cloth covering cloth implement 16 to connect cloth implement 16 to head 12 without an adhesive.

Referring to FIG. 7 is a bathing member 18 that has a sponge implement 16S. Suitable materials for the sponge material include a synthetic sponge that resembles the appearance of a natural sea sponge. One such sponge is obtainable from Spongezz Inc., Ontario, Canada, as the “faux natural cut-form body bath sponge 7300-BK-01.” Natural sea sponges are not as durable and may not stand up to the rigors of use as well as a synthetic sponge. However, some users may still prefer a natural sponge. In some embodiments, the sponge material is attached to head 12 by an adhesive, flame bonding, or the like.

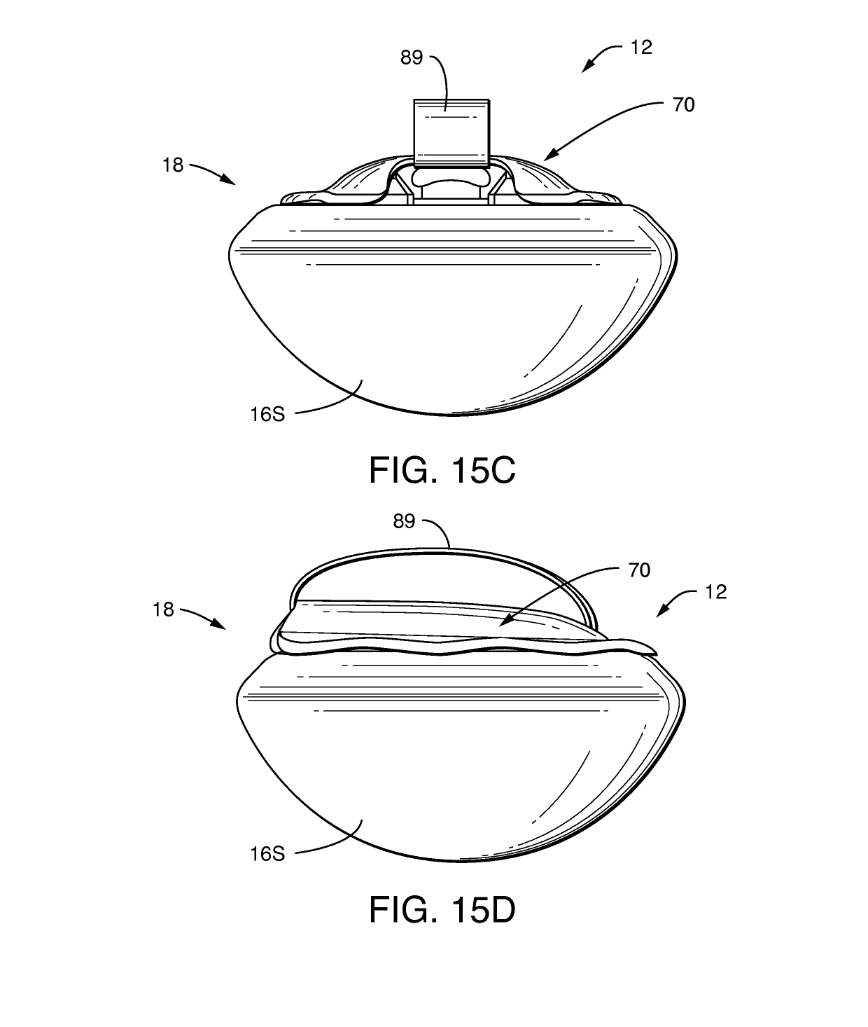

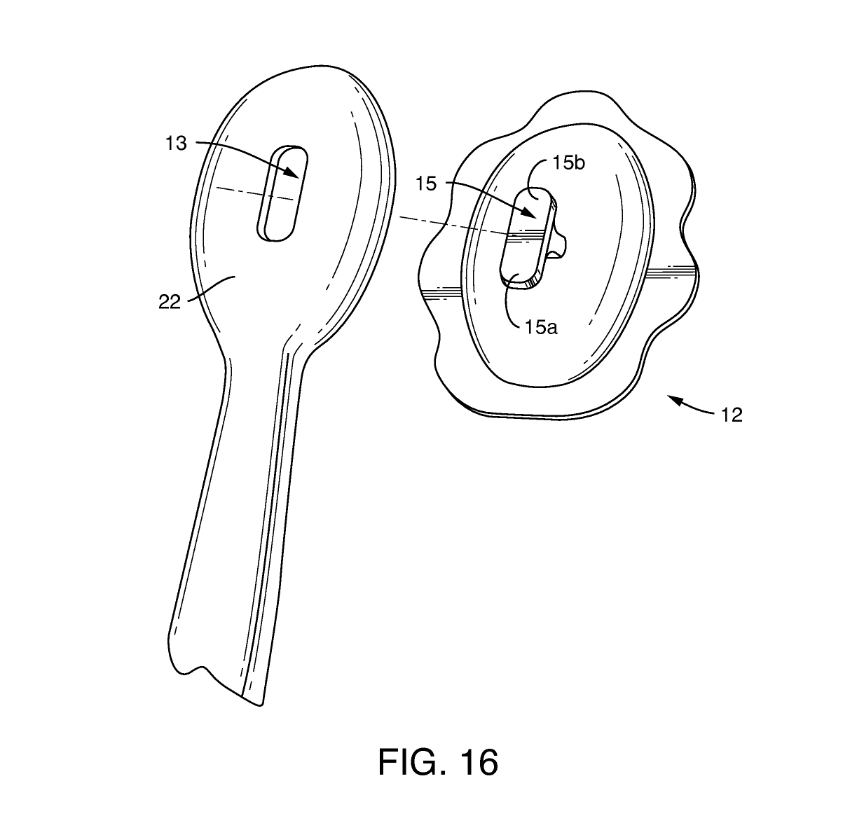

As seen in FIGS. 15A-15D, the bathing member 18 of FIG. 7 is shown in more detail. The footprint of the bathing implement 16S is larger than that of the head 12. For example, the implement 16 may extend beyond the edge of the skirt 72 by approximately 1 cm.

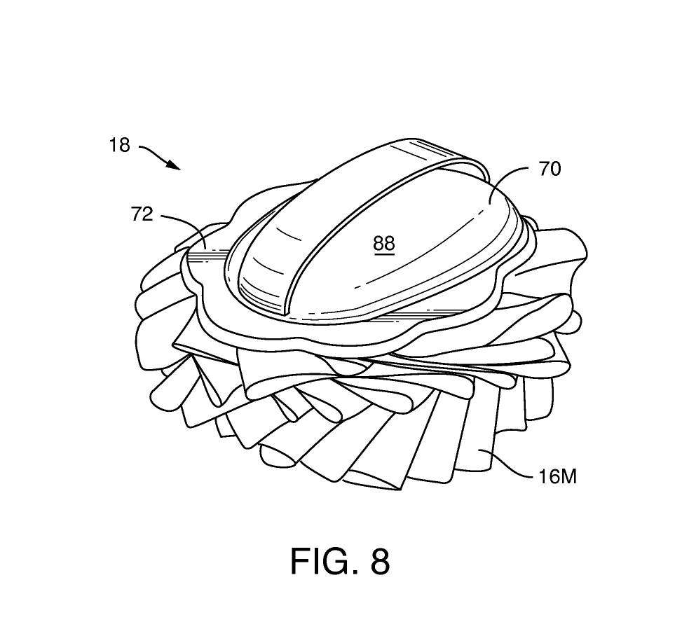

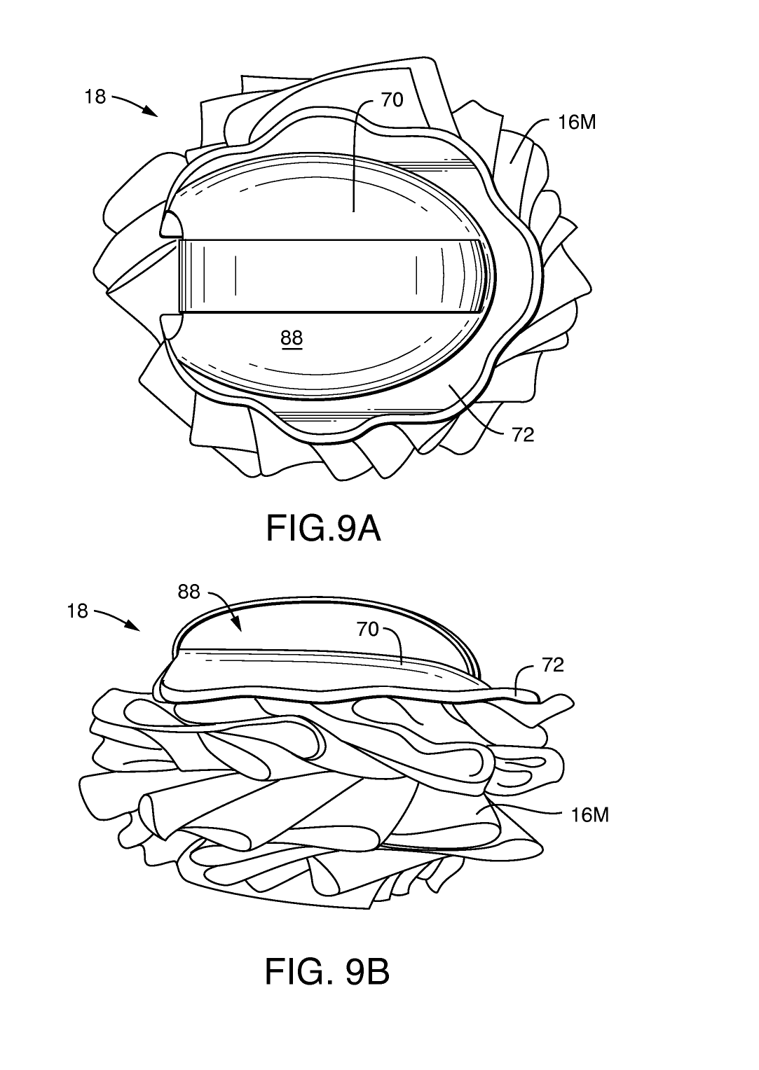

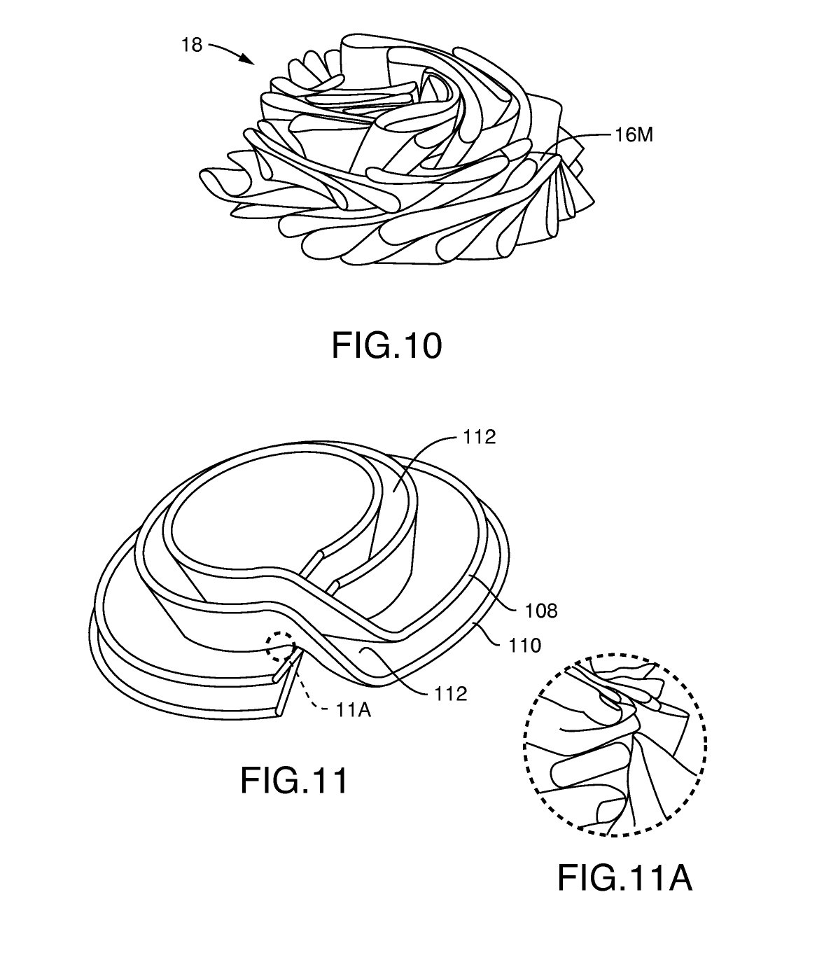

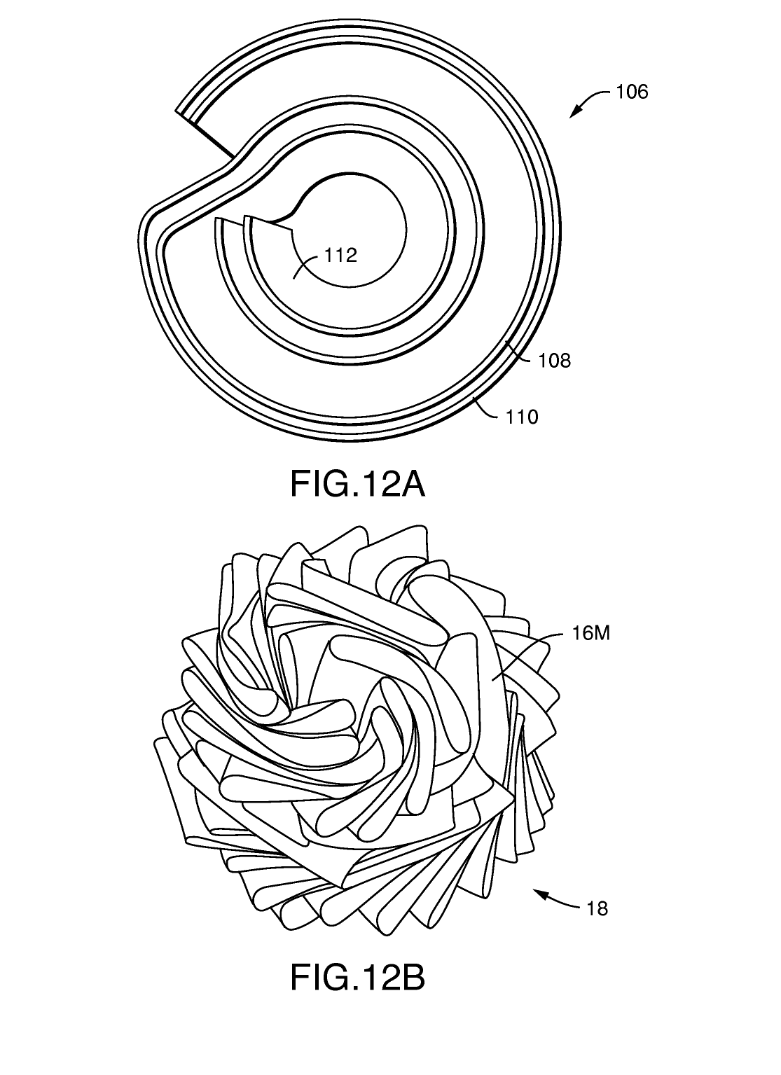

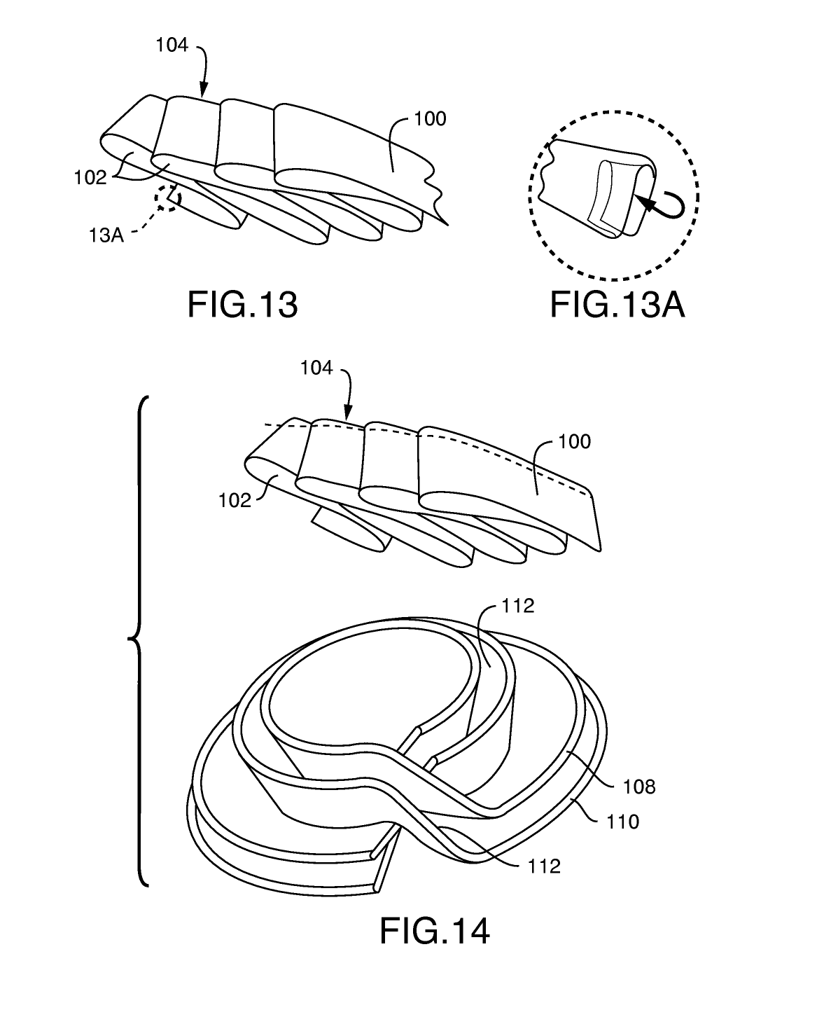

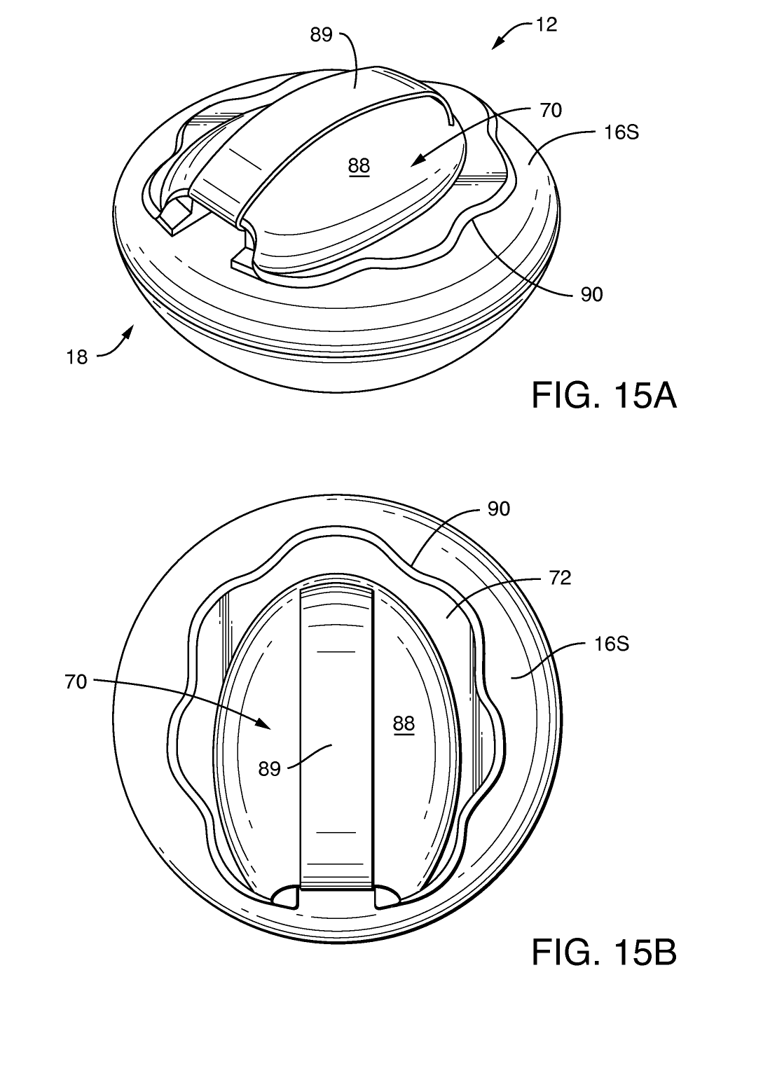

Referring now to FIG. 8-9B, a bathing member 18 has a mesh implement 16M. The mesh implement 16M or pouf may be produced by methods understood by one skilled in the art. The pouf may be produced as a round shape or fanned into a flower shape, or can be any other shape that would be suitable and understood by one of ordinary skill in the art. In one aspect, as seen best in FIGS. 10 and 12B, the mesh is arranged to form a rosette. This is done by taking a mesh ribbon 100 as shown in FIG. 14, folding it into a series of folds 102, and stitching the folded stitched ribbon along one edge 104. The folded, stitched ribbon is then attached to a rosette form 106 as shown if FIGS. 11 and 12A.

As shown in FIGS. 11 and 14, the rosette form 106 can be two concentric spiral members 108 and 110. The spiral members 108 and 110 are nested so that there is a continuous channel 112 therebetween. The folded and stitched ribbon 100 slides into the channel 112 so that the rosette pattern is formed.

To increase the reliability and strength of the bond of various materials of bathing implements 16 to the wand head 12, the wand head 12 can be doped with a polymer, and an adhesive can be selected that comprises that same polymer. For example, it was discovered that an improvement in bonding of various materials for the bathing implements 16 described above (including pouf, sponge, loofah, foam, terrycloth, etc.,) can be more reliably adhered to the wand head 12 by doping the wand head 12 with ethylene vinyl acetate copolymer (“EVA”) and choosing an adhesive that comprises EVA. A typical wand head 12 can include, at least in part, a formulated KRATON styrene block copolymer. Kraton Performance Polymers, Inc. provides the following information about their polymers on their website:
Kraton G SEBS and SEPS polymers are the strongest, the most highly dilutive, and the most compatible with polyolefins and mineral oils of all the styrenic thermoplastic block copolymers. Kraton G polymers are second generation styrenic block copolymers with a hydrogenated midblock of styrene-ethylene/butylene-styrene (SEBS) or styrene-ethylene/propylene-styrene (SEPS). They are intended for use where UV resistance, high service temperature, and processing stability are essential. Kraton G polymers are the material of choice for production of soft, strong compounds for handles and grips, elastic components in diapers, oil gels for telecommunications and medical applications, impact modifiers of engineering thermoplastics, flexibilizers/tougheners for clear polypropylene.

While the typical wand head 12 may include a KRATON styrene block copolymer, the bathing surface may be made of a significantly different type of material such as a brush (of natural or synthetic bristles), a “pouf” (which may include a polyolefin material), a sponge (which may be natural or formed of a polyurethane material), a “loofah”, a foam material or a cloth, such as a terrycloth fabric. These various bathing surfaces are not naturally compatible for attachment to a bathing wand head 12 composed at least in part of a KRATON styrene block copolymer. A benefit of the present disclosure is the recognition that attachment of the materials to each other is improved when an adhesive material including an ethylene vinyl acetate copolymer is used.

In order to show the benefits described above, a variety of adhesives were evaluated; samples of the following adhesives were obtained from Henkel Corporation: G02 glue (available from Loctite, this glue is a hybrid of polyurethane and polyoxysilane; described as being “water resistant”), LOCTITE STIK'N SEAL glue (specifically, STIK'N SEAL Outdoor Adhesive; a synthetic rubber adhesive that is described as being “water resistant”) and LOCTITE super glues. Additionally, the following hot melt adhesives available from Henkel Corporation were also evaluated: TECHNOMELT PUR 3631; TECHNOMELT PUR 513C-300; and LOCTITE A-633. Further, the following polyolefin elastic adhesive was evaluated: TECHNOMELT 6009s. Two ethylene vinyl acetate-based hot melt adhesives were also evaluated: TECHNOMELT AS 8843 and TECHNOMELT 740. The polyurethane-based hot melt adhesives showed poor bonding between a wand head including a KRATON styrene block copolymer and a polyurethane sponge material; in particular, the sponge could be easily peeled off of the wand head 12. The polyolefin elastic hot melt adhesive provided attachment initially, but the attachment weakened when the composite structure (wand head, bathing surface and adhesive material) was “aged” in soapy water at about 40 to 50 degrees Celsius. Without being bound by theory, it is believed that temperature resiliency is poor for polyolefin elastic adhesives in these executions. The super glues performed well with good temperature (50 degrees Celsius) and soapy water resilience. A significant downside to using a super glue as an adhesive material is cost and processing hurdles including the strong smell from the isocyanate and solvent components of the super glue.

The adhesive testing further showed that using an adhesive material containing EVA high melt flow rate polymer can improve attachment results. Further, EVA high melt flow rate adhesives are more cost effective. The EVA high melt flow rate polymer adhesive is compatible with each of the substrates desired to be attached to each other including a wand head 12 including a KRATON styrene block copolymer (substrate of a first material) and [(i) a sponge including polyurethane; (ii) terry cloth including cotton; and (iii) pouf including a polyolefin- (each a substrate of a second material)]. In addition to being a component of the adhesive material, the EVA high melt flow rate polymer is also added to the wand head 12 material in an amount of at least 10% by weight and up to 30% by weight. Addition at 20% by weight is desirable. The melt flow rate of the EVA polymer additive is at least >5 and up to >/=100 of the melt flow rate of the bulk polymer of the wand head 12 (substrate of a first material); desirably, the melt flow rate is >10. The EVA polymer additive needs to have a higher melt flow rate than the bulk polymer in order for it to migrate to one end surface of the wand head 12 during molding.

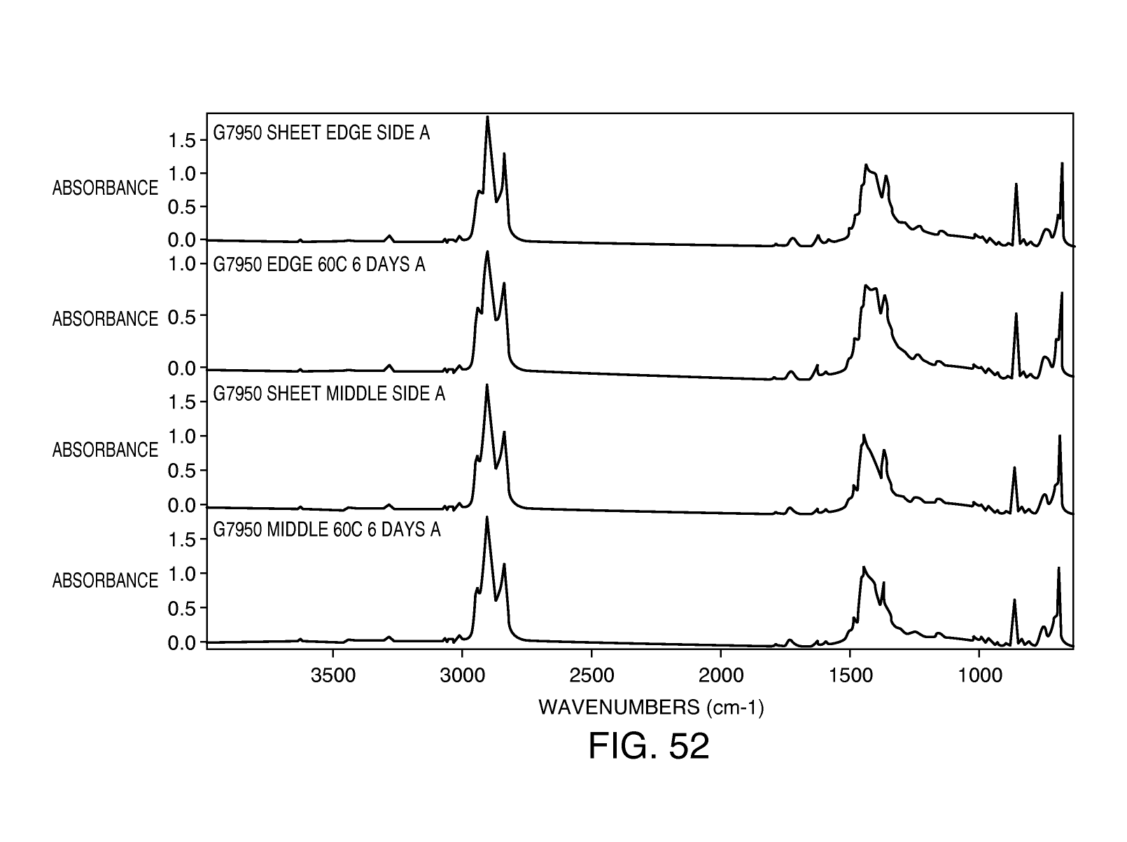

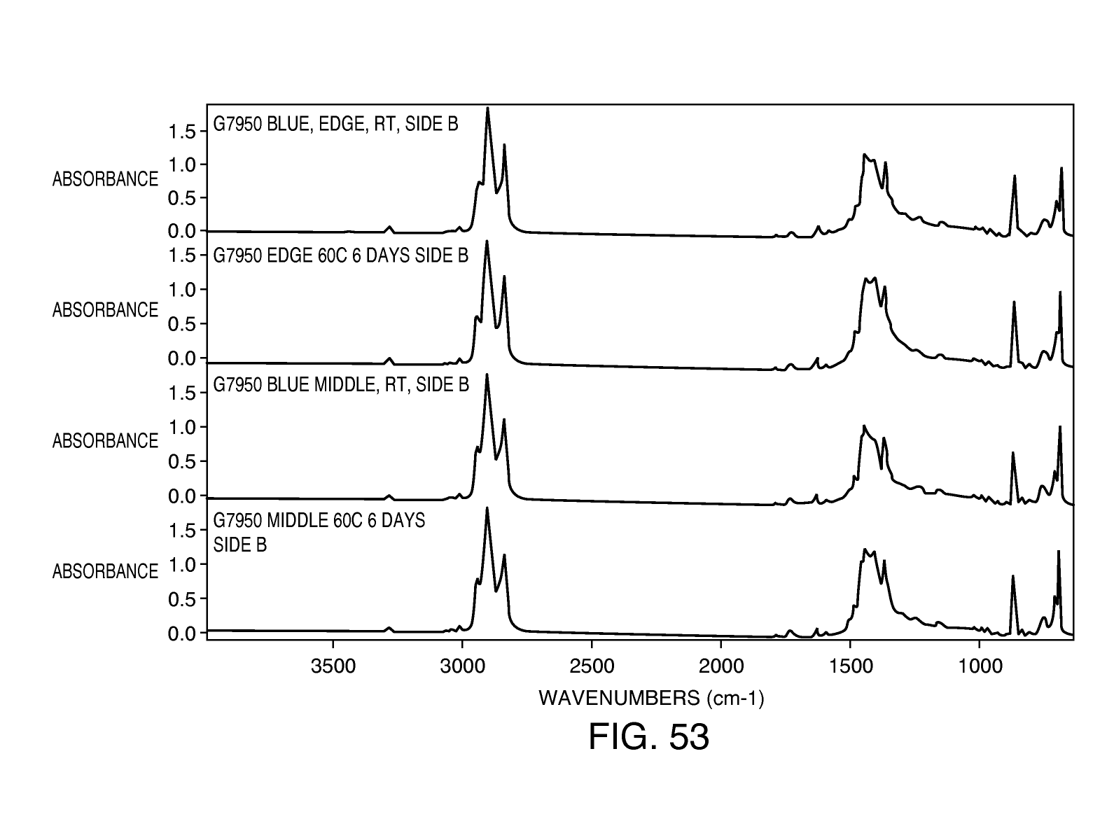

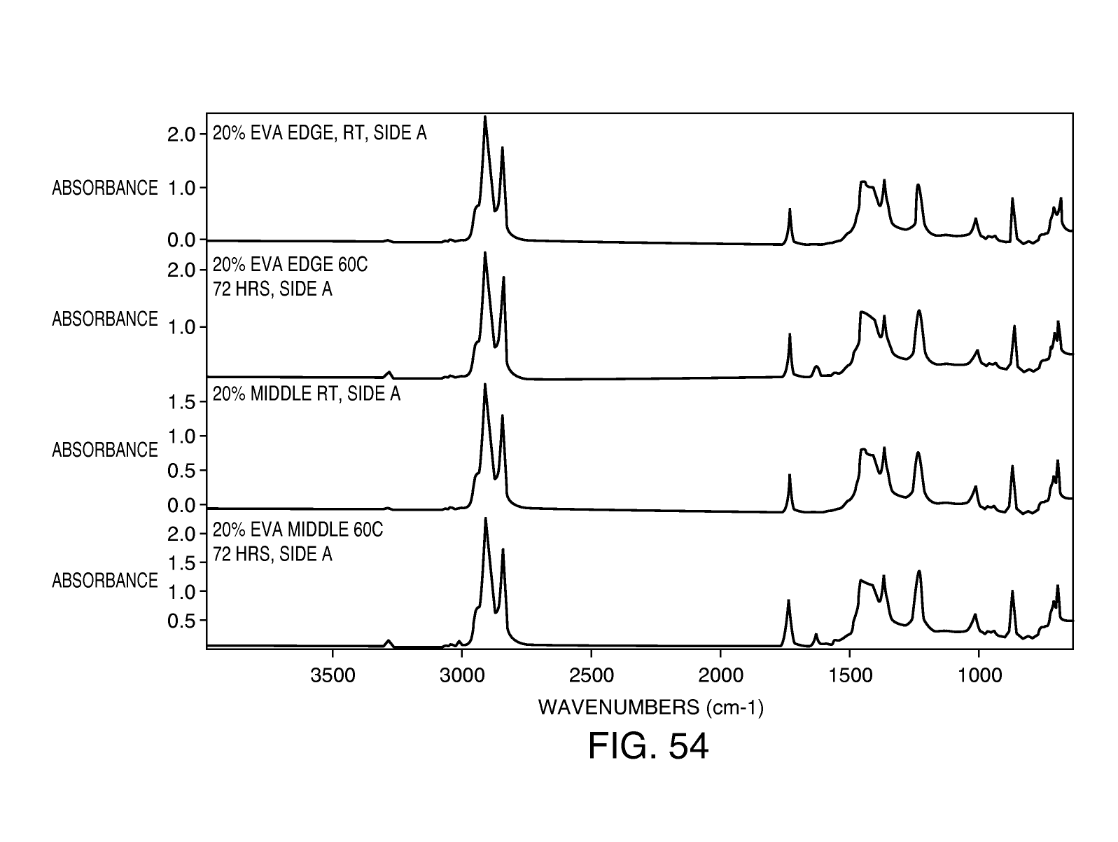

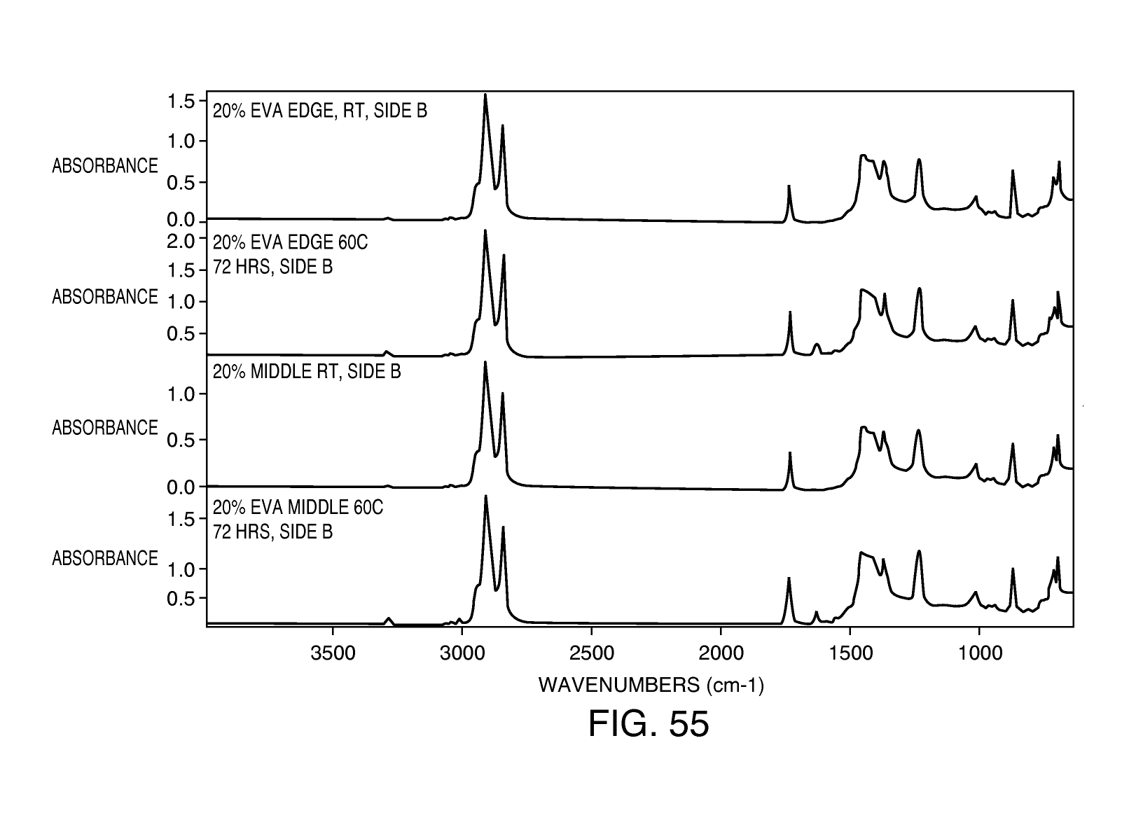

In an example of the present invention, the wand head 12 (or other substrate of a first material) may be formed of G7950 polymer. G7950 is a KRATON-type, styrene block copolymer available from PolyOne Corporation. When a wand head 12 formed of G7950 polymer is attached to a bathing implement 16 (or other substrate of a second material)—such as a pouf, sponge or terry cloth—using an EVA-based high melt adhesive such as H740 (or other, ethylene vinyl acetate copolymer containing adhesive material), the bonding strength is weak. However, when 20% EVA is added to the G7950 polymer used to form the wand head 12, the bonding strength to the bathing surface 16 is stronger and more resilient. The improved bonding strength appears to be attributable to a difference in surface composition between a wand head composed of 100% G7950 polymer and a wand head composed of G7950 polymer blended with 20% EVA polymer. The difference in surface composition is evidenced in the infrared (“IR”) spectroscopy results shown in FIGS. 52-55. IR spectra of each side and two different locations (edge and middle) of sheets made of 100% G7950 polymer (FIGS. 52-53) and G7950 polymer+20% EVA copolymer (FIGS. 54-55) were created. In addition to the sheets in their original conditions, IR spectra were also taken of each sheet (and each side and each position) after they were placed in a PYREX beaker and aged at 60 degrees Celsius in an oven for 6 days (for the 100% G7950 polymer samples); and for 72 hours (for the G7950 polymer+20% EVA copolymer samples). As a result of the EVA polymer appearing to migrate to the surface, there was an improvement in surface tension/energy as measured by contact angle. The contact angle for 100% G7950 polymer was 67 degrees and the contact angle for the G7950 polymer+20% EVA copolymer was 61 degrees. Without intending to be bound by theory, this difference is believed to be the reason why a wand head composed of G7950 polymer+20% EVA copolymer (first substrate of a first material) was securely bonded to bathing surfaces of a pouf (polyolefin material), a sponge (polyurethane material) and a terry cloth (cotton) (each an example of a second substrate of a second material) using the TECHNOMELT 740 adhesive (an example of an adhesive material containing an EVA copolymer). No bonding failure occurred—with any of the three bathing surfaces—after 2000 cycles (using a Gardner Scrub Tester) in 40 degrees Celsius soap water with 500 grams of force. This was the result even though all of the samples were “aged” in 50 degrees Celsius soap water for 96 hours prior to the scrub testing. Each sample was inspected for bonding failure at five minute increments up to 25 minutes.

EVA-based hot melt adhesives can be difficult to use in processing because of their fast set times. For example, TECHNOMELT 740 adhesive has an open time of less than 10 seconds. Open time is also dependent on the add-on level and the temperature of the substrates being bonded. If infrared heating is used during assembly, the open time may be increased. TECHNOMELT AS 8843 adhesive showed a longer open time, but the bonding strength is not as good as the TECHNOMELT 740 adhesive.

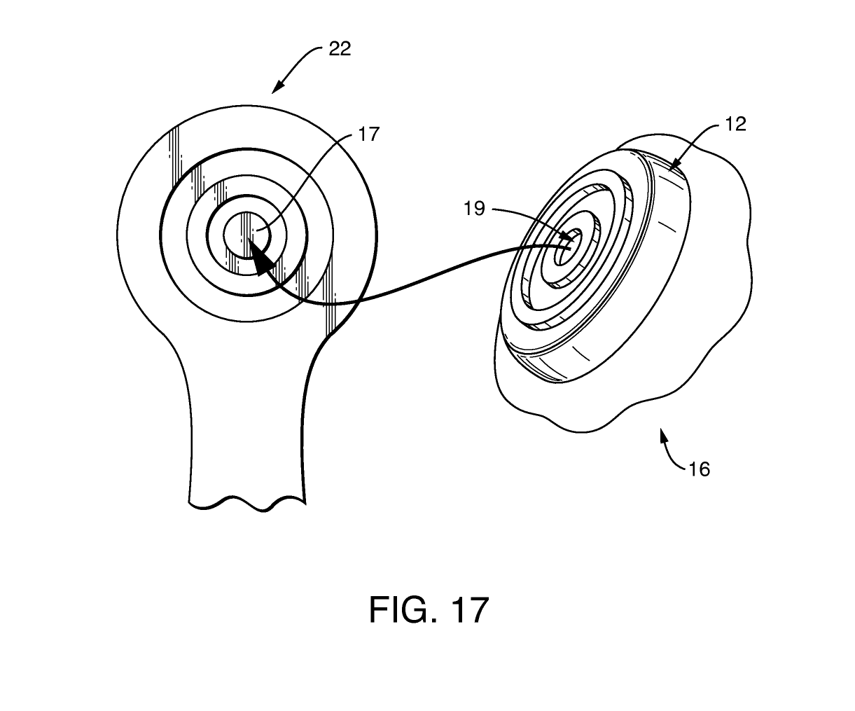

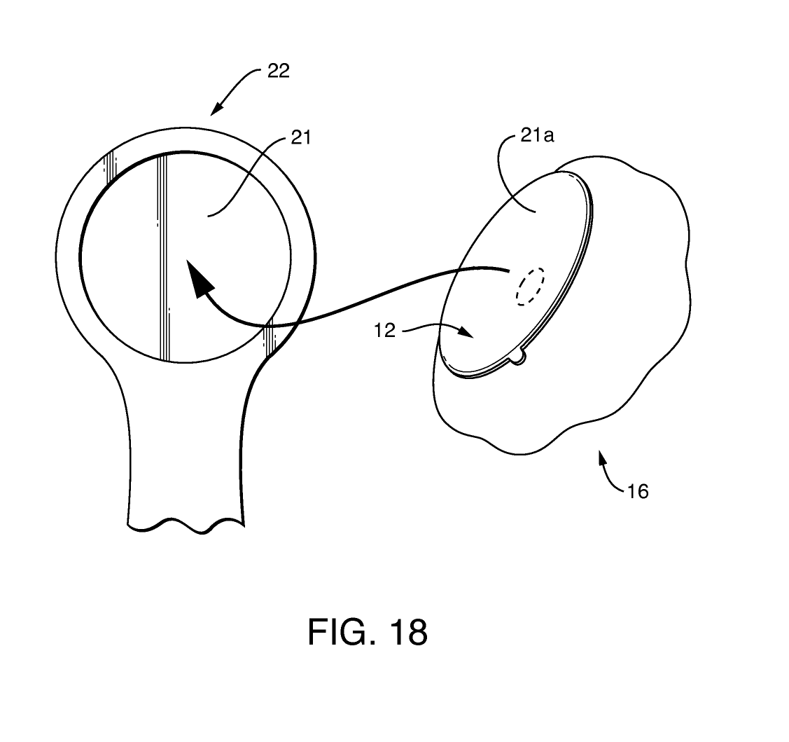

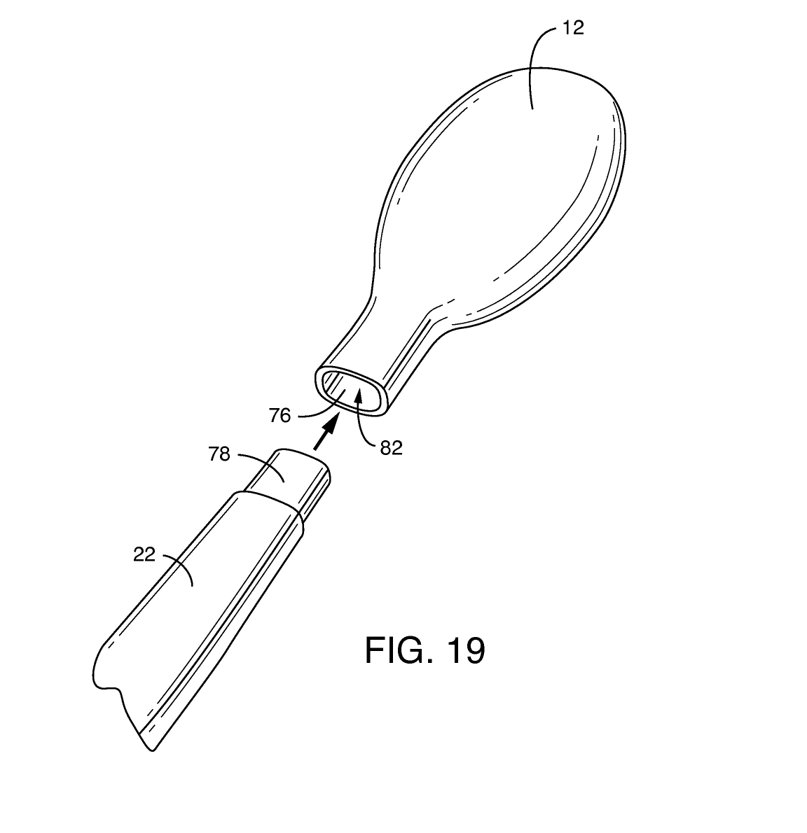

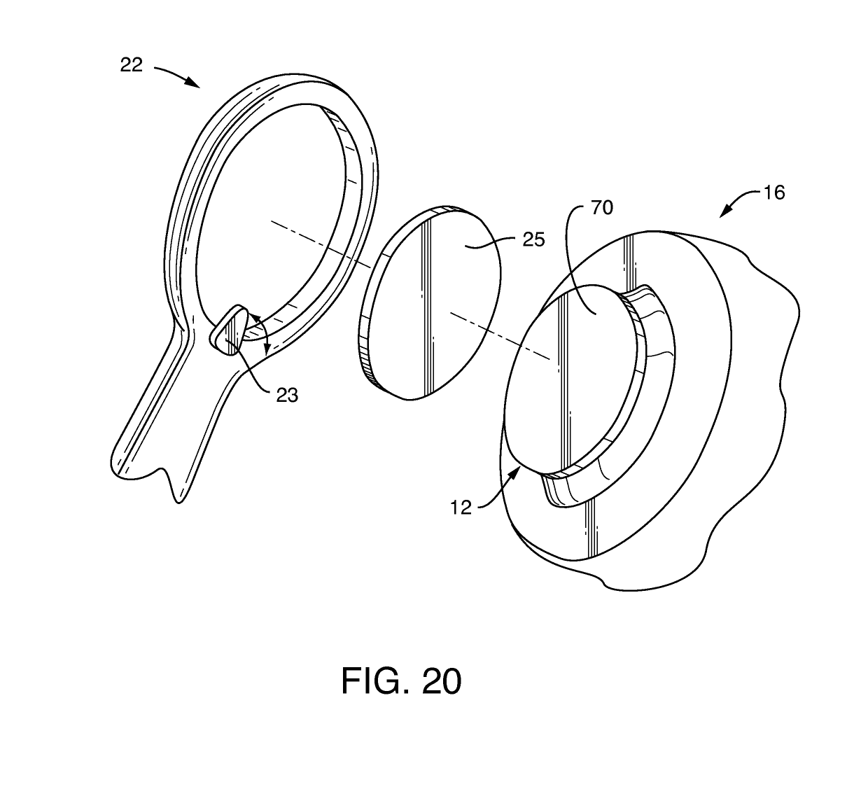

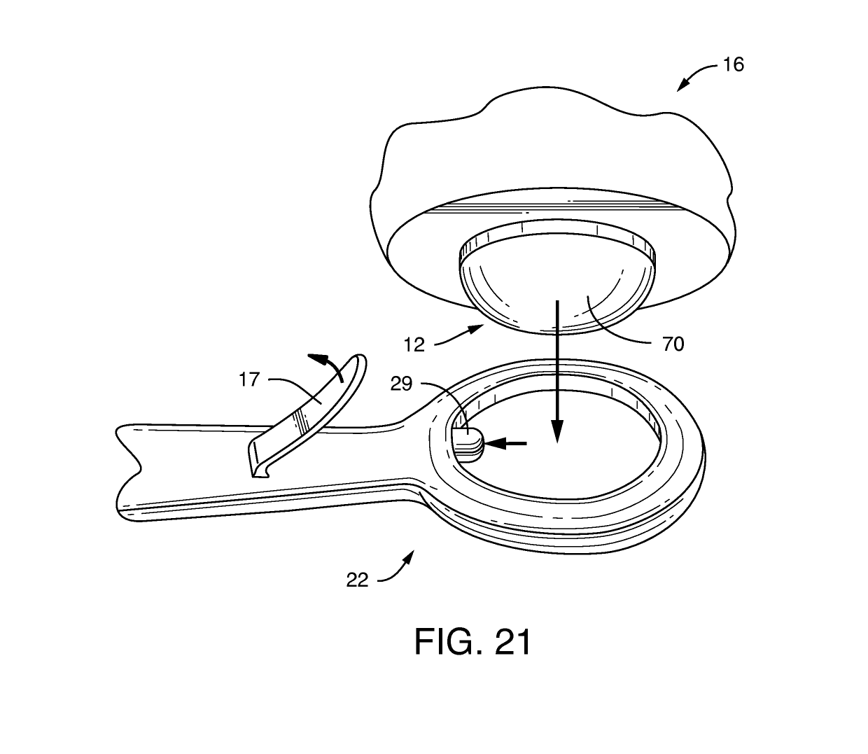

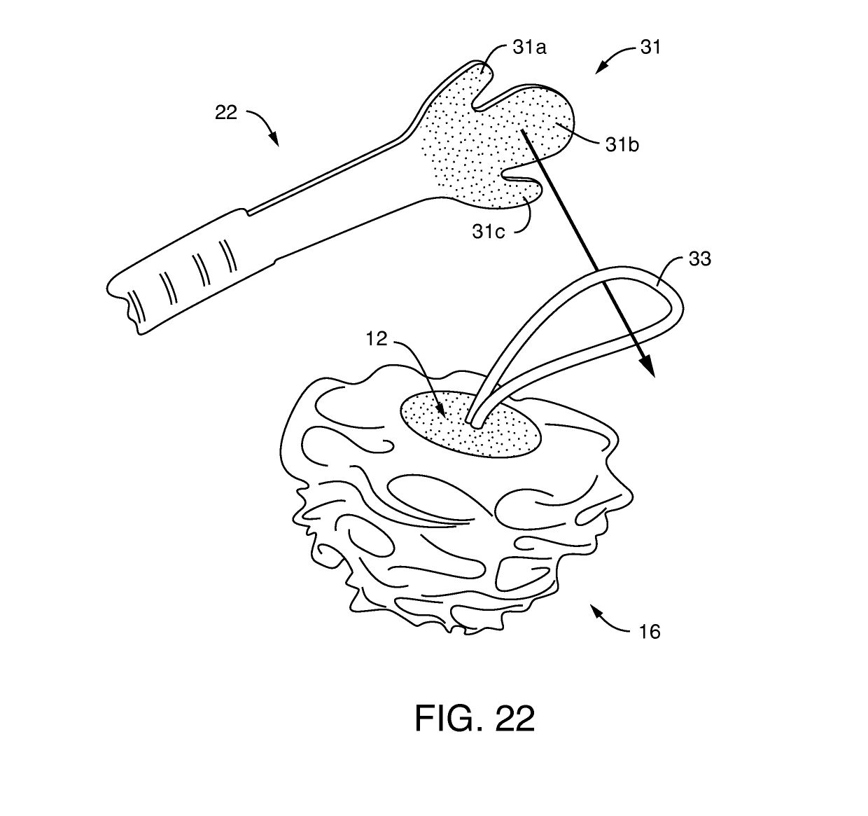

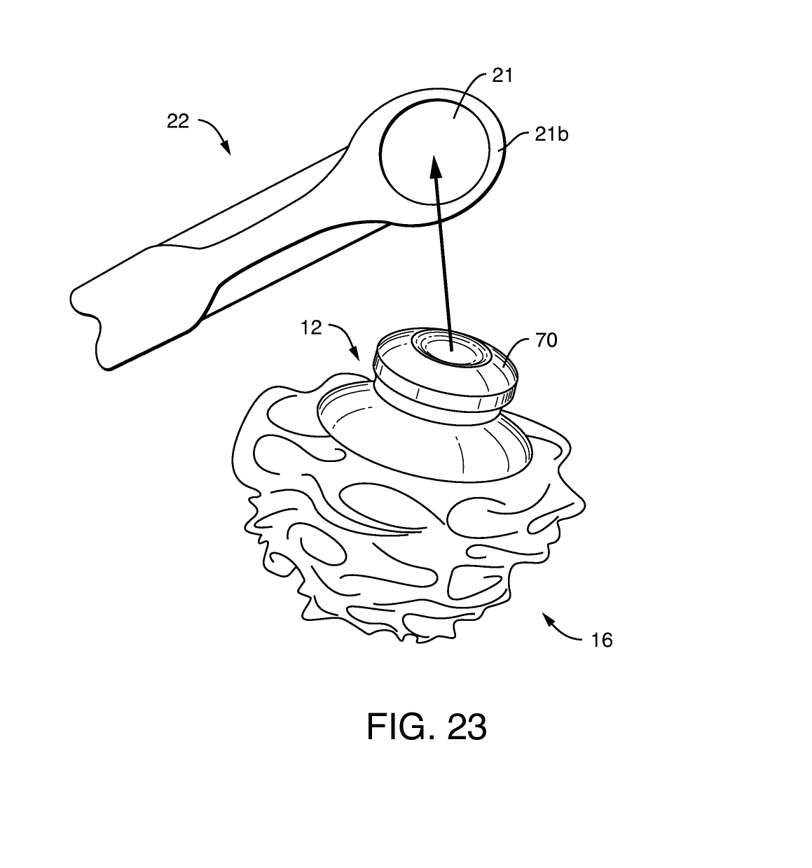

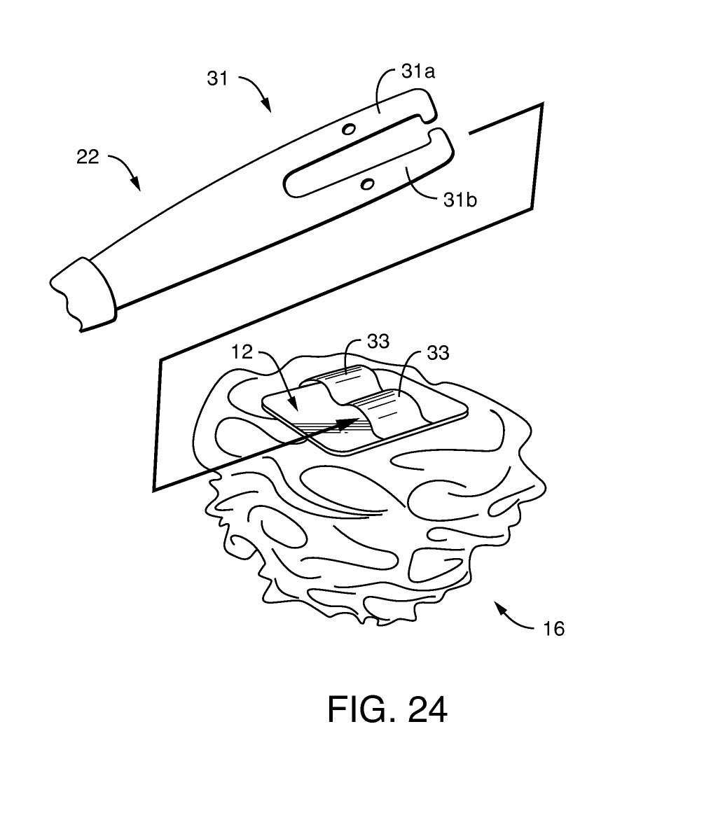

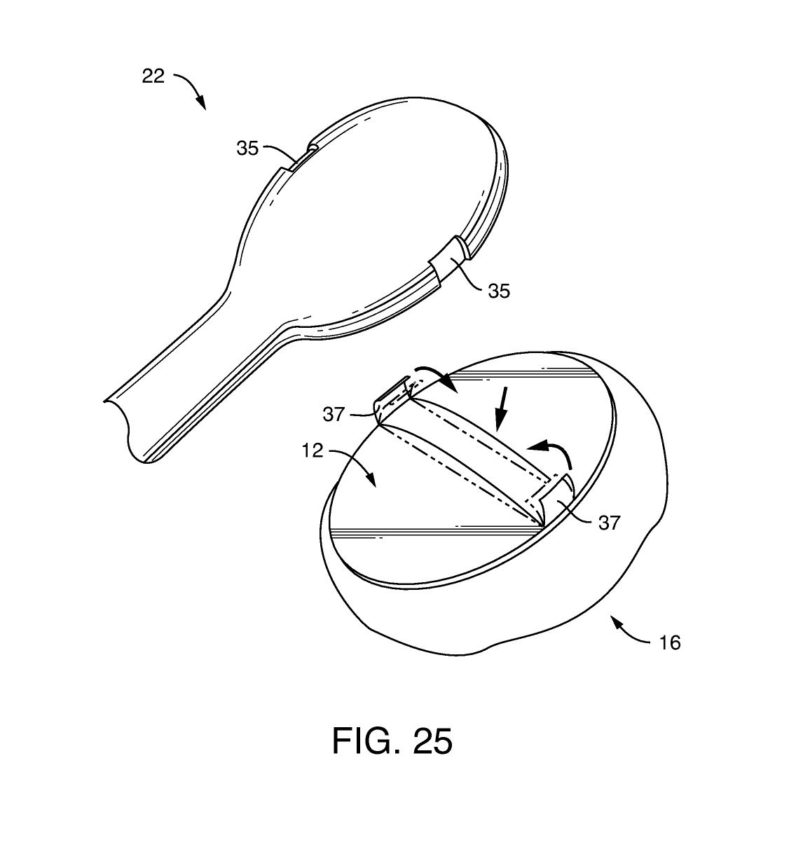

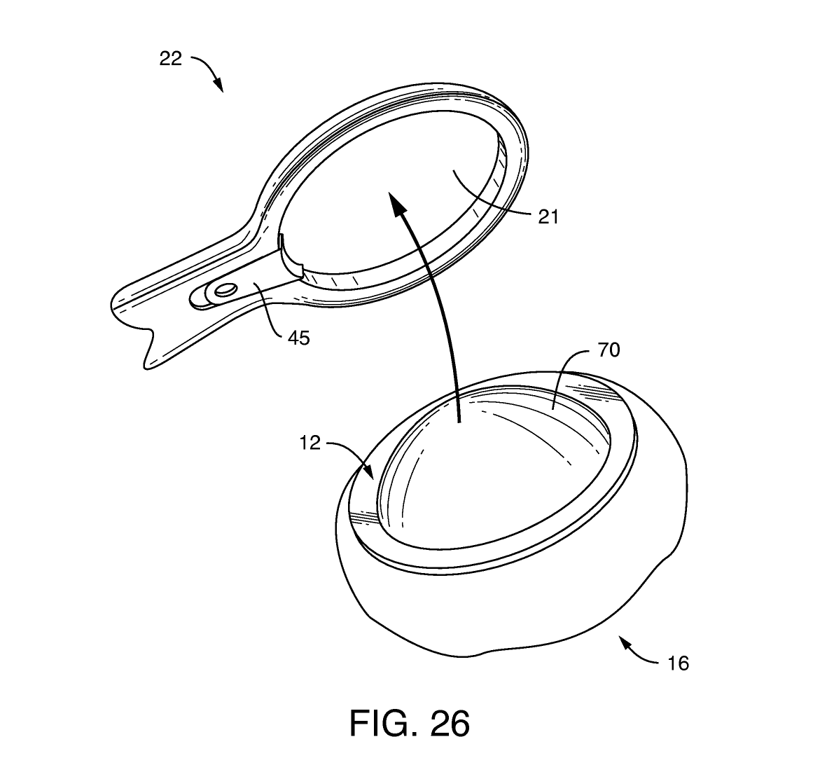

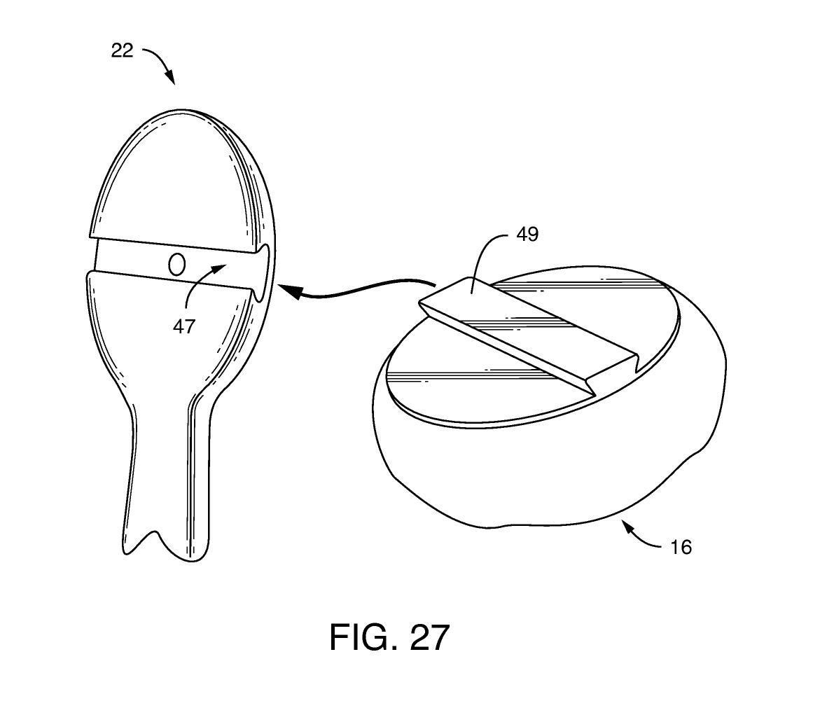

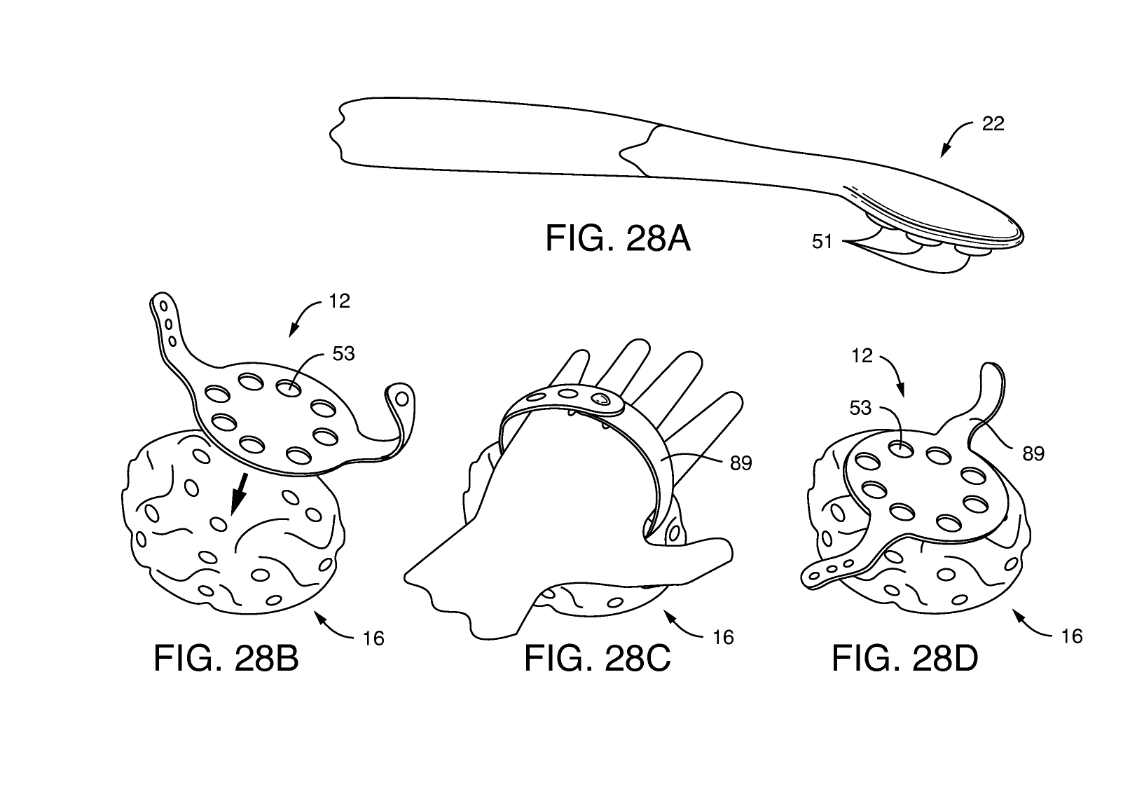

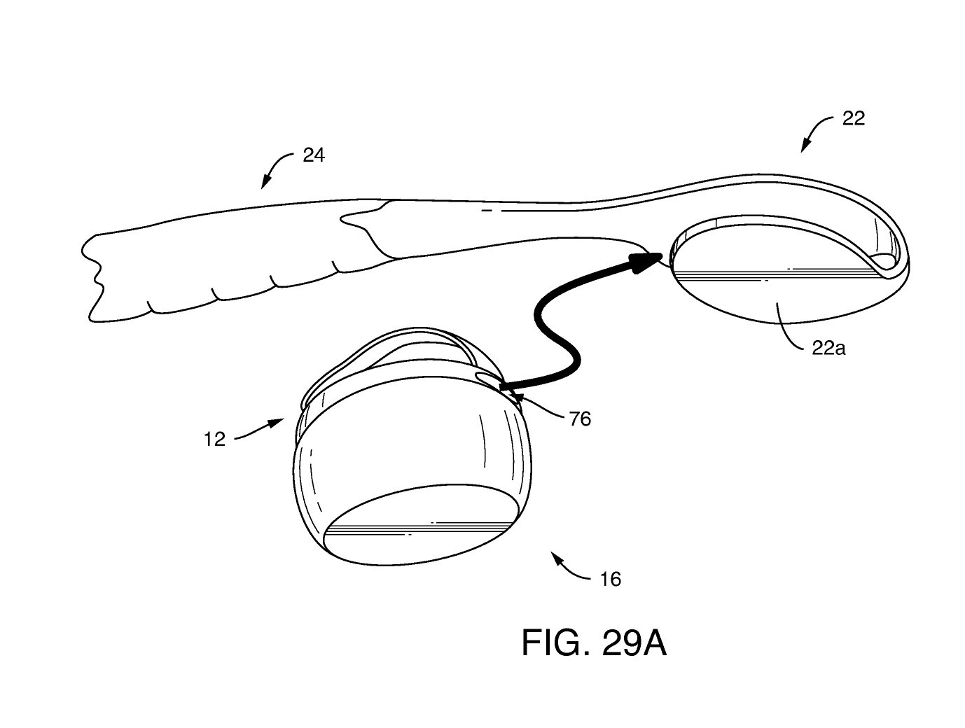

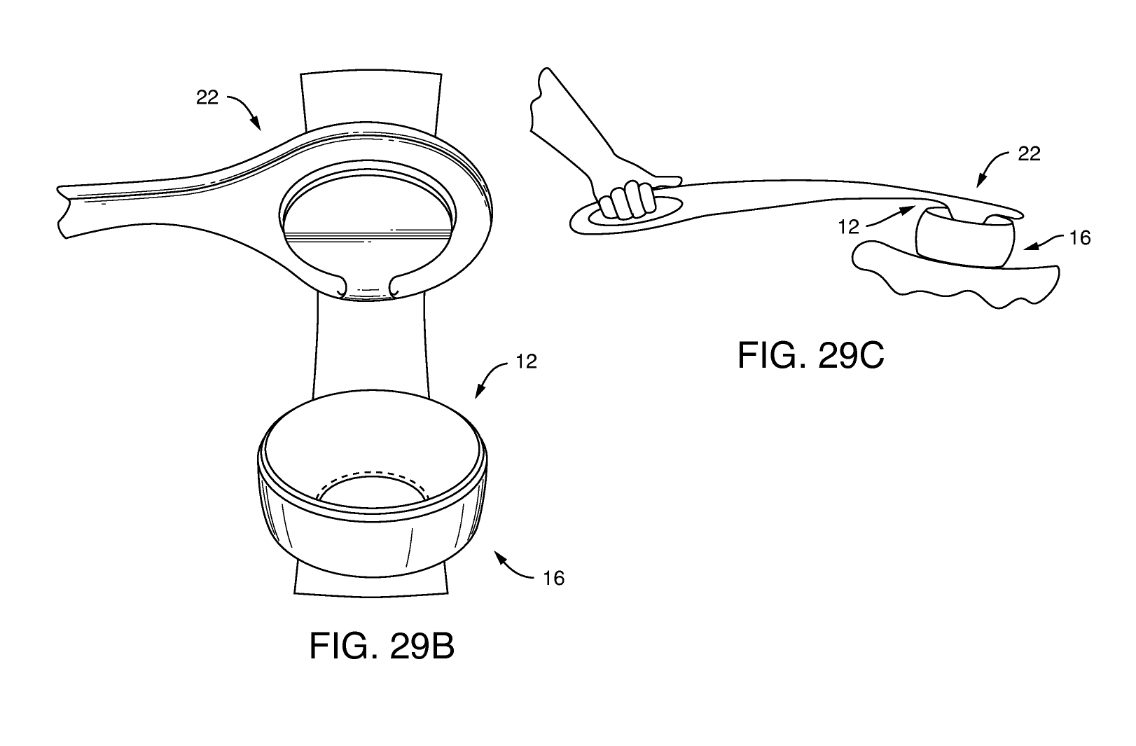

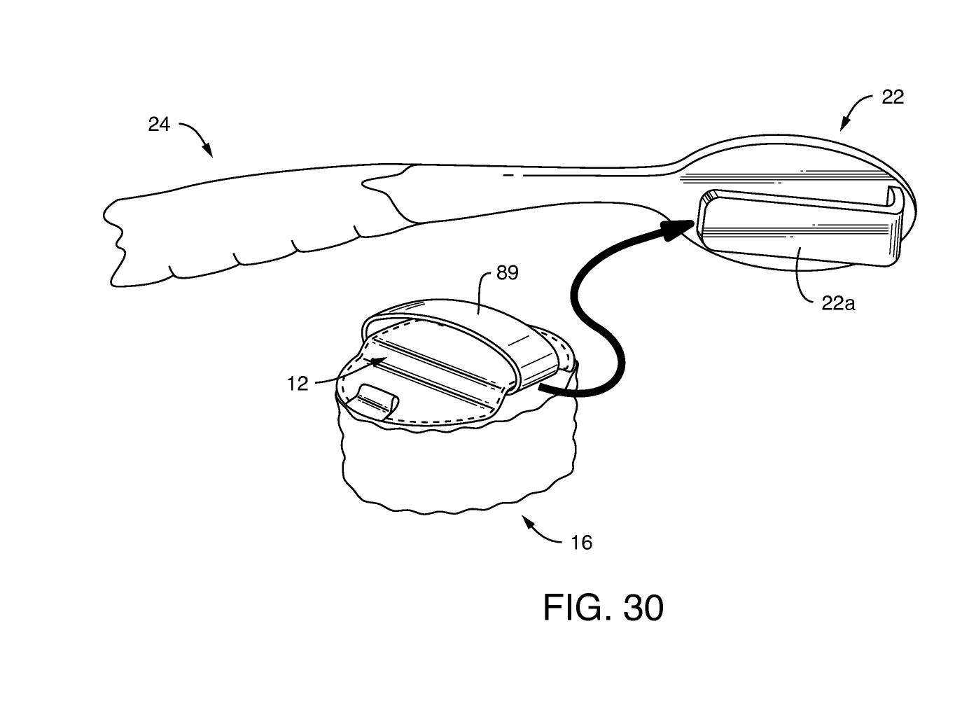

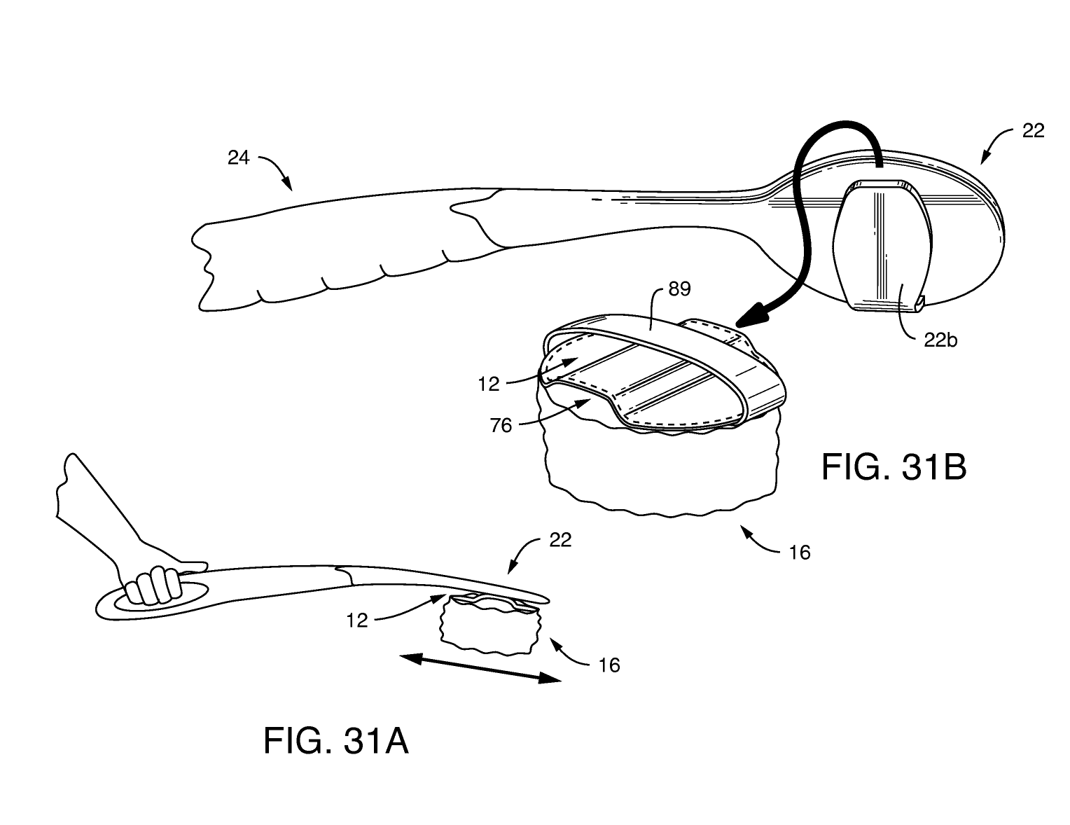

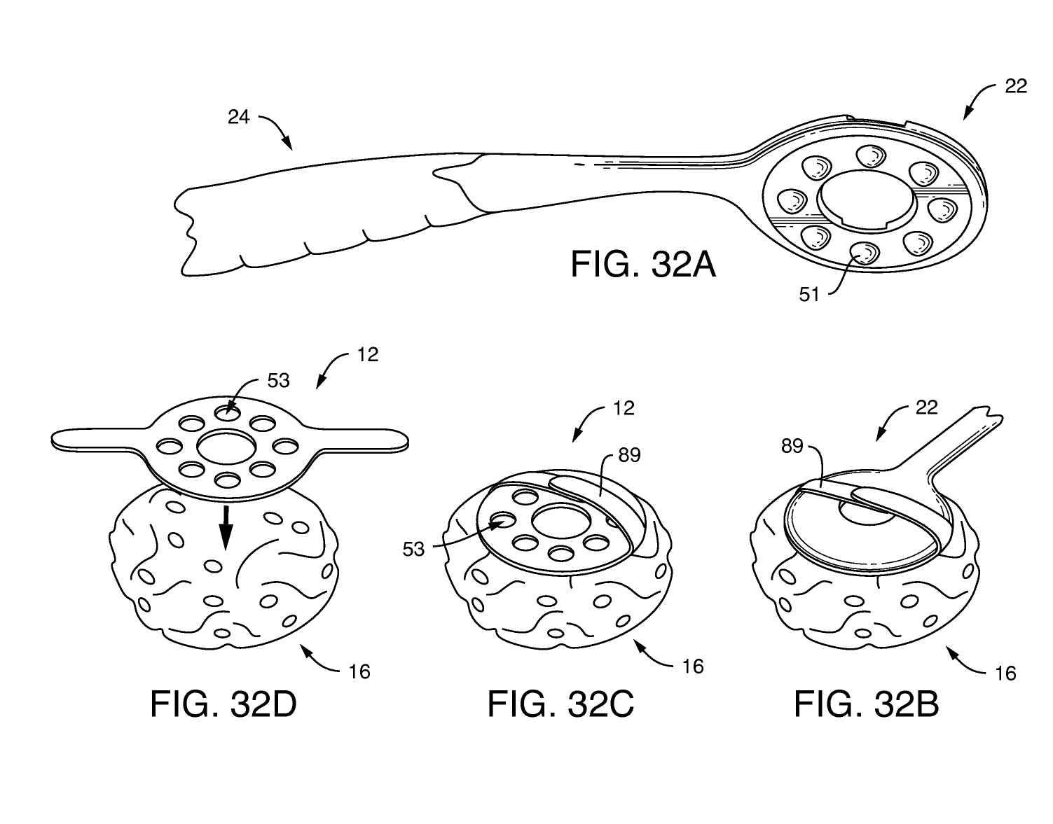

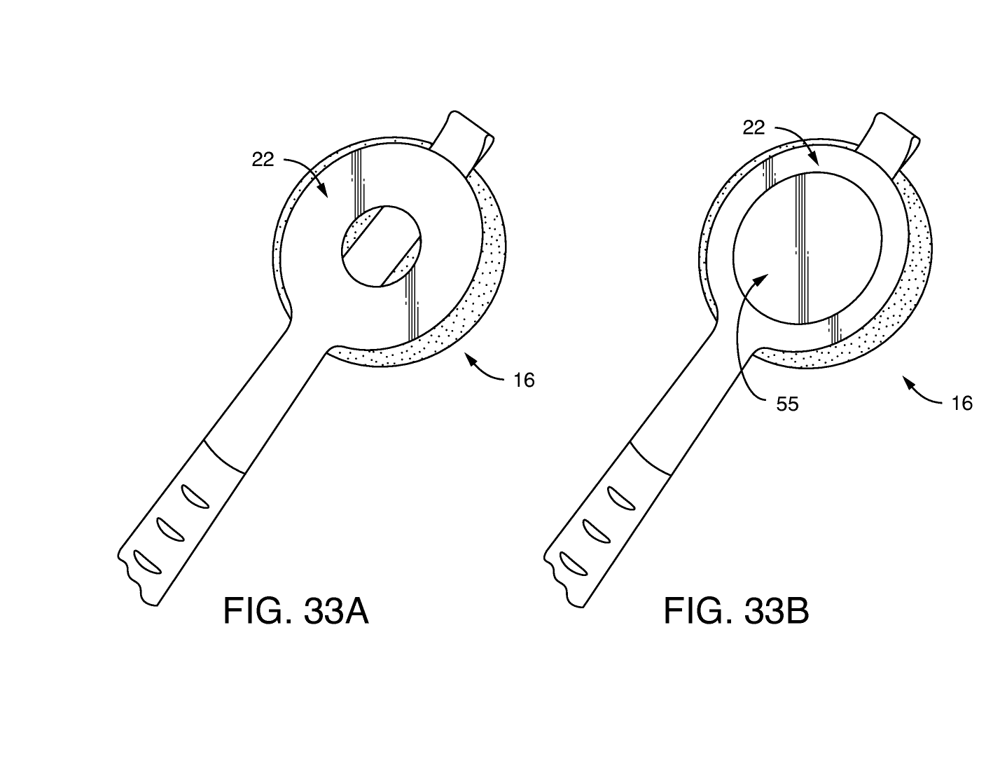

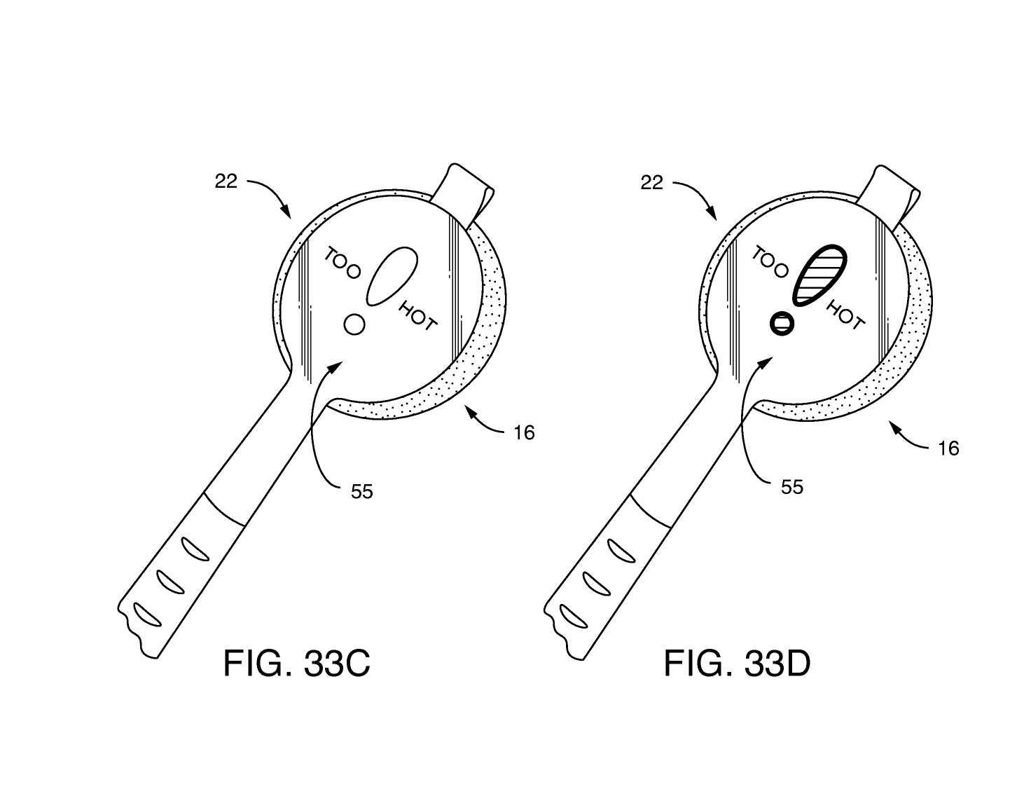

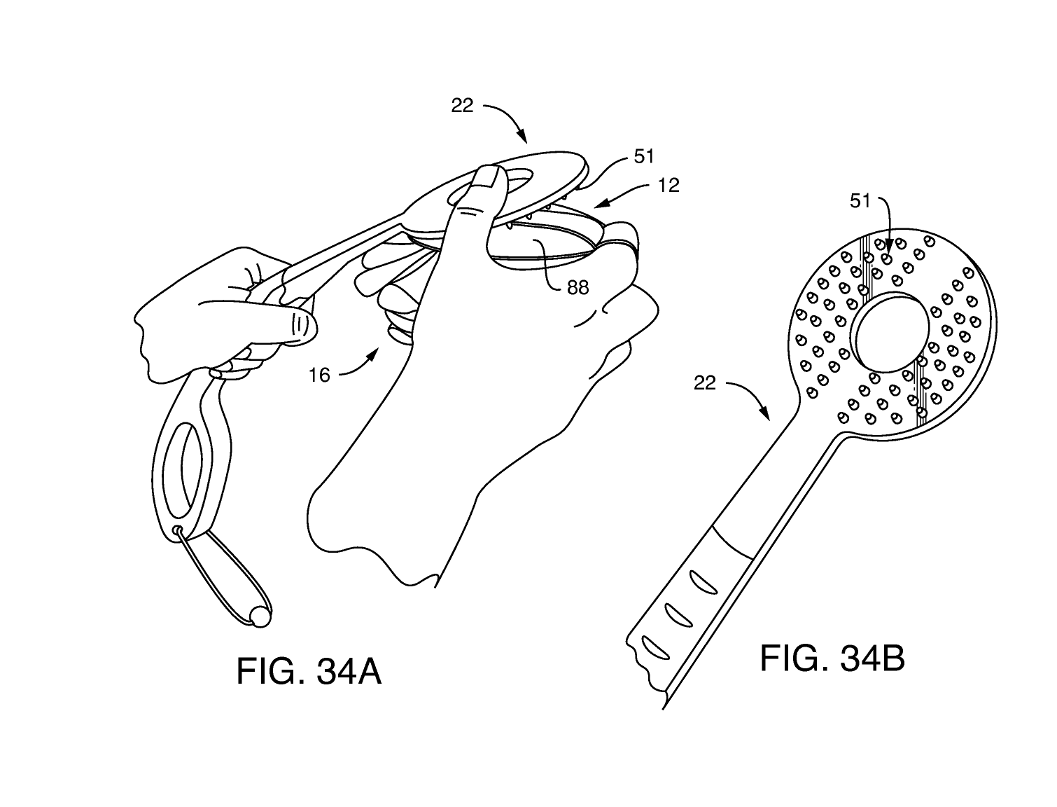

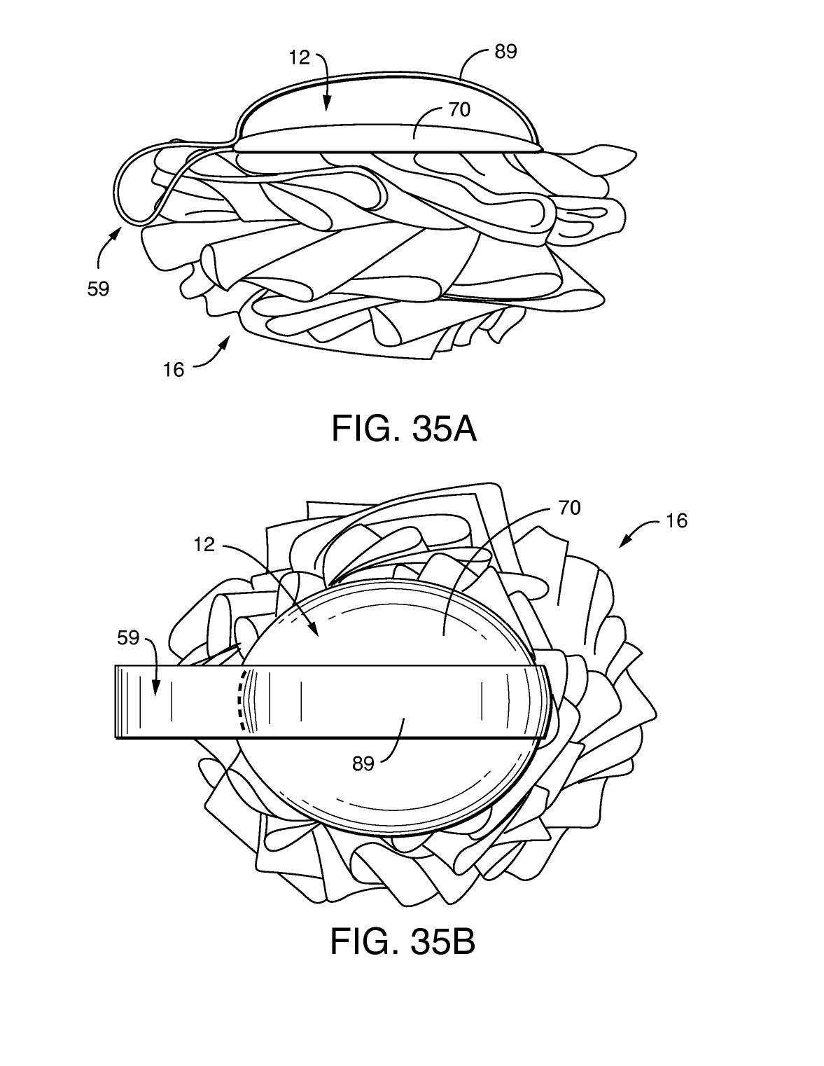

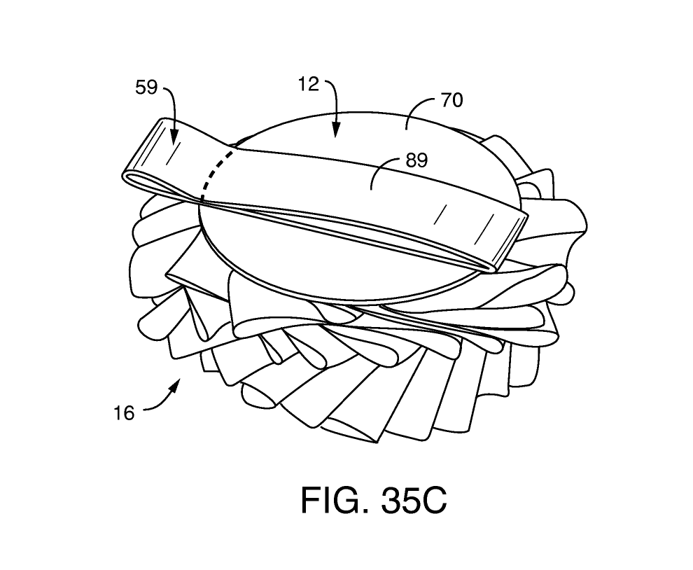

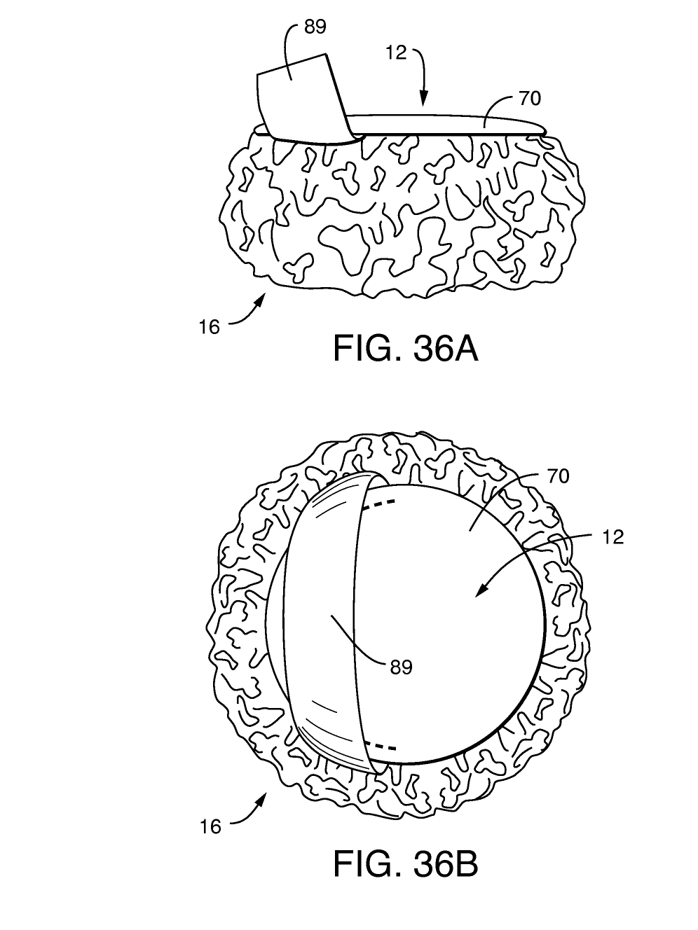

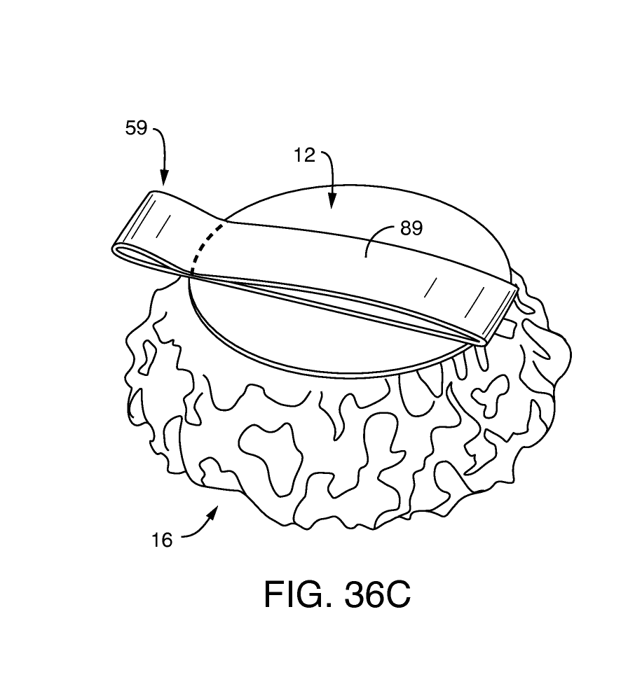

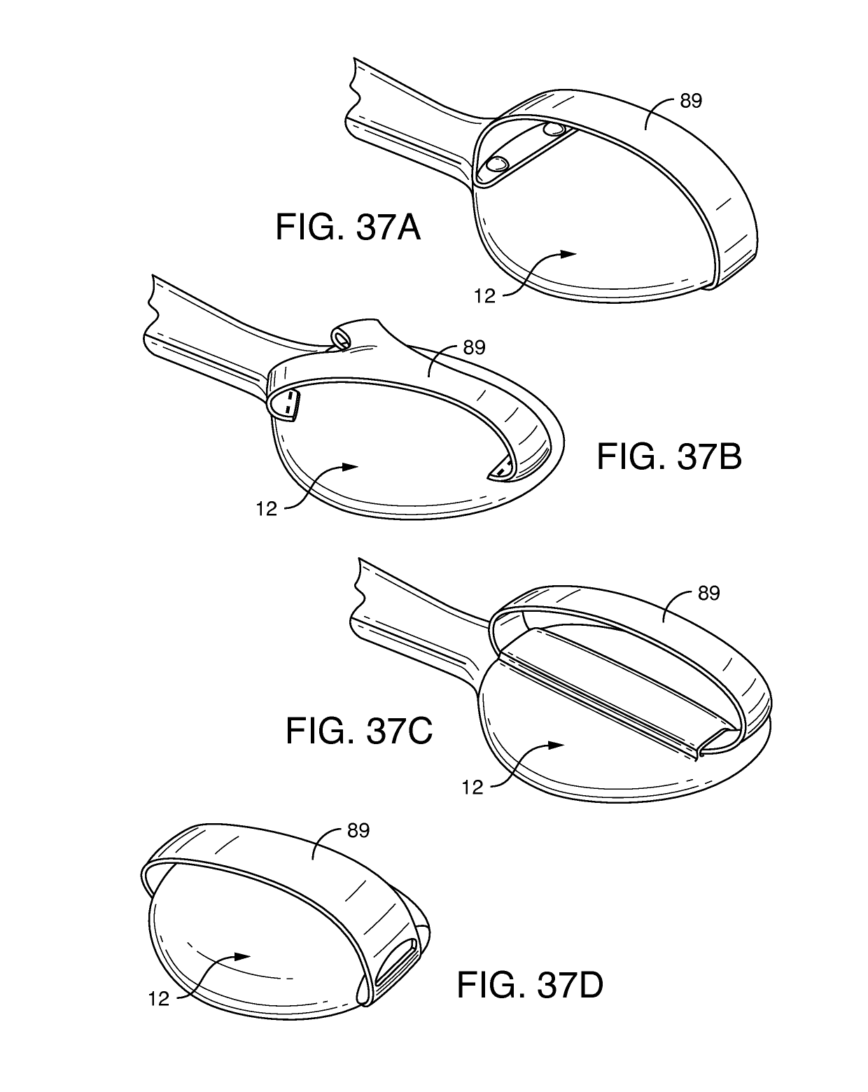

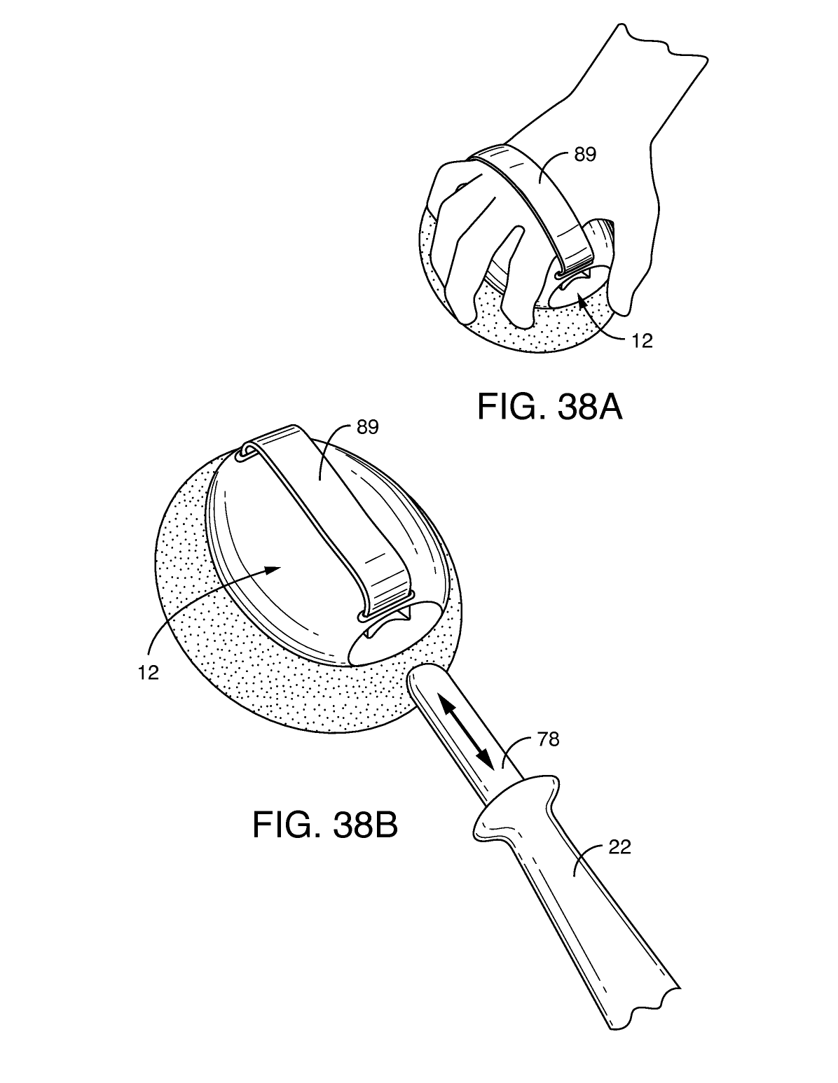

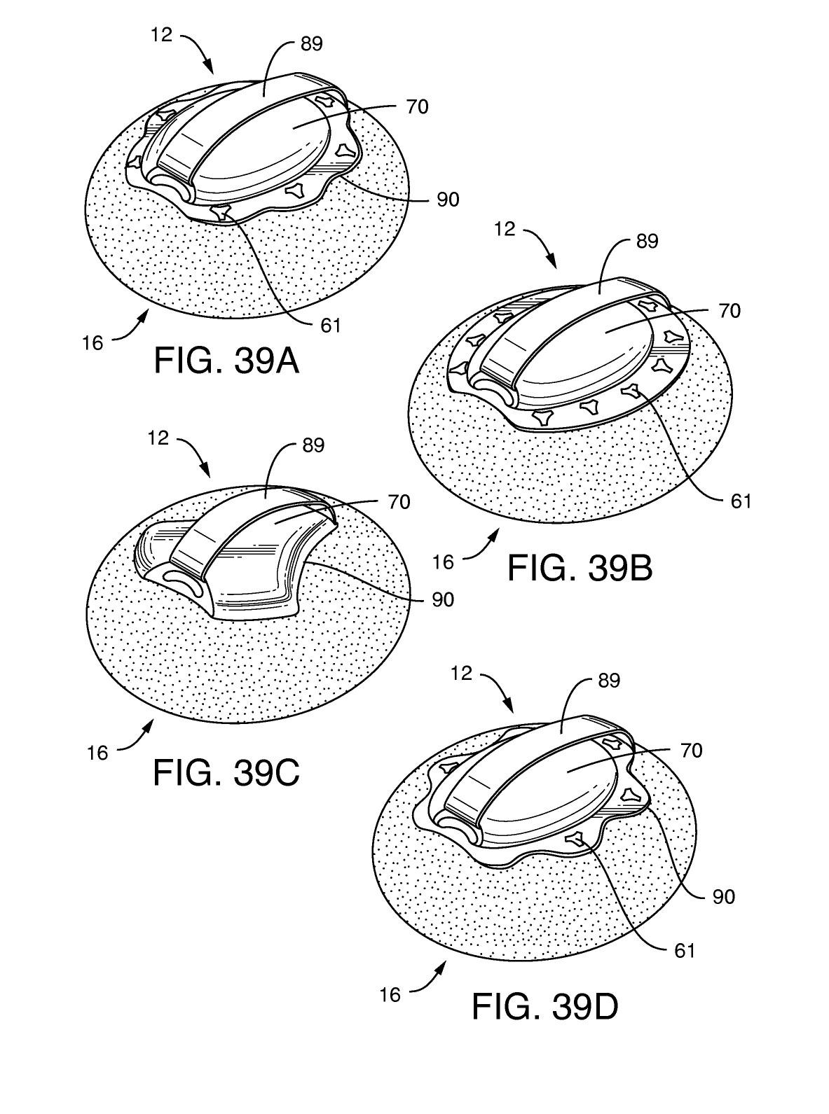

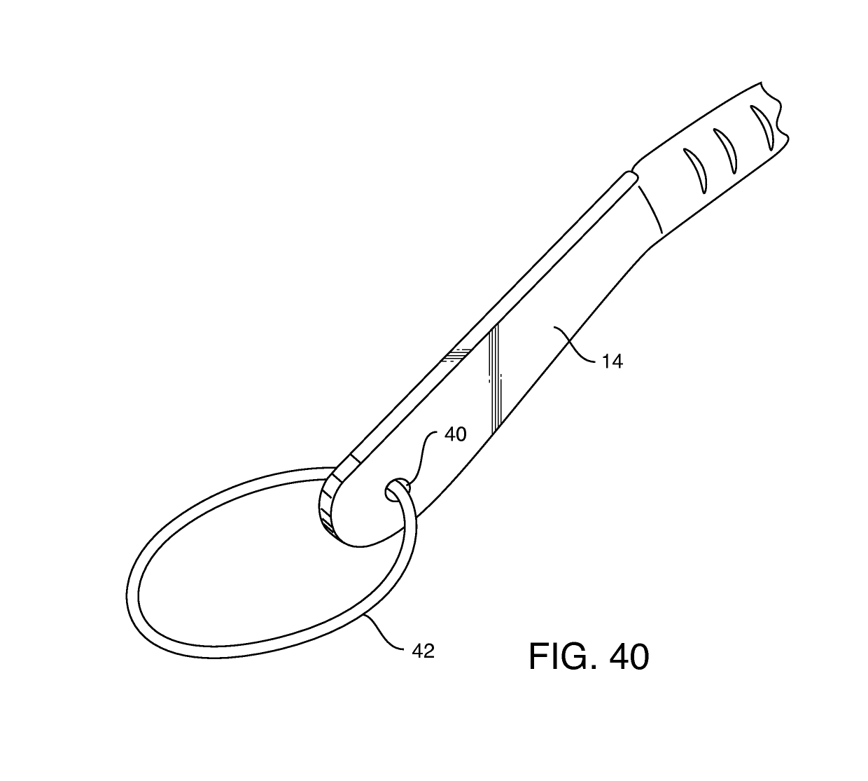

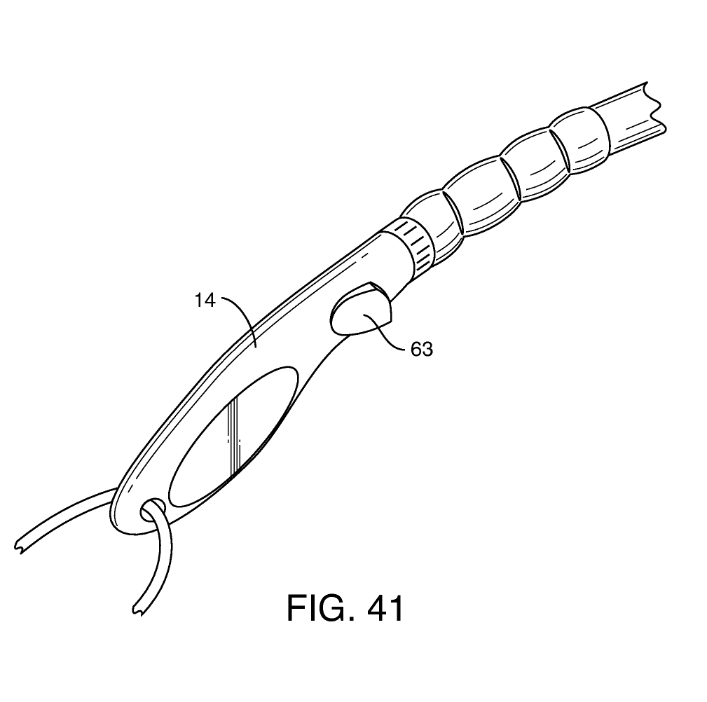

FIGS. 16-39 depict various alternative head attachment designs. For example, FIG. 16 depicts a neck 22 with an elongated aperture 13 that receives a projection 15 of the wand head 12. The projection can include arms 15a, 15b. Once inserted through the elongated aperture 13, the projection 15 can be rotated 90 degrees such that the arms 15a, 15b extend past the elongated aperture 13 and securely attach the wand head 12 to the neck 22. FIG. 17 depicts a neck 22 with a projection 17 that is received in an aperture 19 on the wand head 12. FIG. 18 depicts a neck 22 including a recess 21 that is sized to receive a suction cup 21a on the wand head 12. FIG. 19 depicts a stem 78 being received by an open end 82 of a receiver 76 in wand head 12. FIG. 20 depicts a neck 22 with a rotating lever 23 that can secure an intermediate member 25 and the domed section 70 of wand head 12. FIG. 21 depicts a neck 22 including a lever 27 coupled to arm 29, the lever 27 being pulled back to receive the domed section 70 of the wand head 12 and being released to attach the wand head 12 with arm 29. FIG. 22 depicts a neck 22 with a projection 31 including arms 31a, 31b, 31c that can receive a loop 33 on the wand head 12. FIG. 23 depicts a neck 22 including a recess 21 defined by a stretchy ring 21b, the stretchy ring 21b being configured to extend over a domed section 70 of the wand head 12. The domed section 70 can include a reservoir for soap. FIG. 24 depicts a neck 22 with a projection 31 including arms 31a, 31b that can be received loops 33 on the wand head 12; the loops 33 can be used as finger holes if the wand head 12 is used independently from the neck 22 and handle 14. FIG. 25 depicts a neck 22 including two opposing guides 35 that can receive flexible arms 37 of the wand head 12 for a “spring click” fit. FIG. 26 depicts a neck 22 that includes a recess 21 and an axially sliding lever 45 that can receive the domed section 70 of the wand head 12, the axially sliding lever 45 providing a snug fit on the domed section 70. FIG. 27 depicts a neck 22 including a keyway 47 that can receive a mating key 49 on wand head 12. FIGS. 28A-28D and 32A-32D depict a neck 22 including a series of projections 51 that can be received in mating holes 53 in the wand head 12. The wand head 12 can include a strap 89. The strap 89 can extend around the neck 22. FIGS. 29A-29C and 30 depict a neck 22 that includes a projection 22a that is turned back towards arm 24, the projection 22a being received by a receiver 76 in the wand head 12. FIGS. 31A and 31B depict a neck 22 including a projection 22b turned 90 degrees from the orientation of the arm 24 of the bathing wand 10. The lateral projection 22b can be received by a receiver 76 in the wand head 12. FIGS. 33A-33D depict a neck 22 that can provide temperature measuring means 55 that can sense and provide temperature feedback indicia, e.g. (“too hot”). FIGS. 34A and 34B depict a neck 22 including a plurality of projections 51 that can engage in an upper surface 88 of the wand head 12. FIGS. 35A-35C and 36C depict a strap 89 including a lower loop 59 on the domed section 70 of wand head 12. FIGS. 36A and 36B depict a strap 89 on the domed section 70 of want head 12, where the strap is off-center on the domed section 70. FIGS. 37A-38B depict various strap 89 orientations on the domed section 70 of the wand head 12. FIGS. 39A-39D depict various configurations of the outer edge 90 of the skirt 72 of the domed section 70 of the wand head 12. The skirt 72 can include indicia 61, and in some circumstances, the indicia 61 can be aligned with the peaks in the undulating outer edge 90 of the skirt 72.

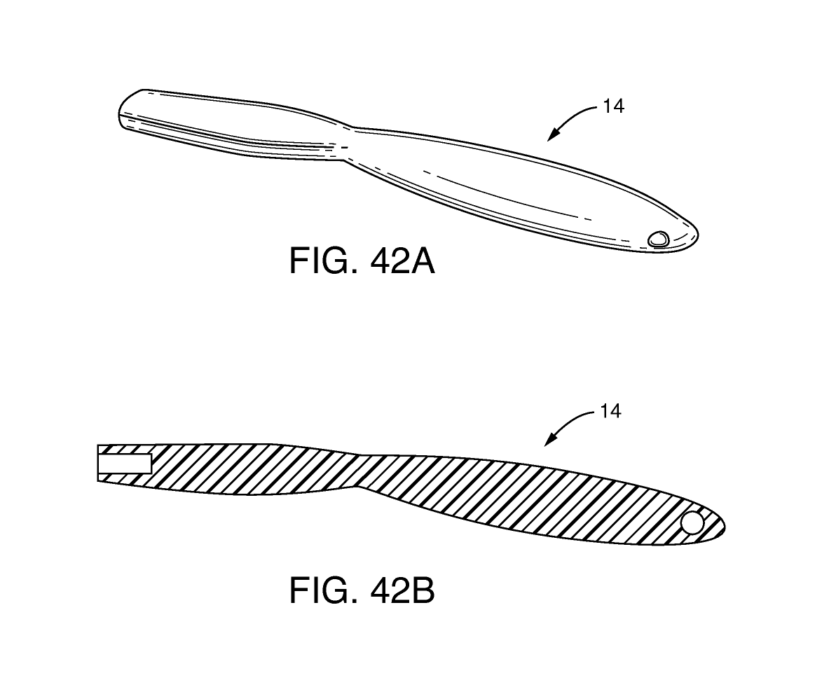

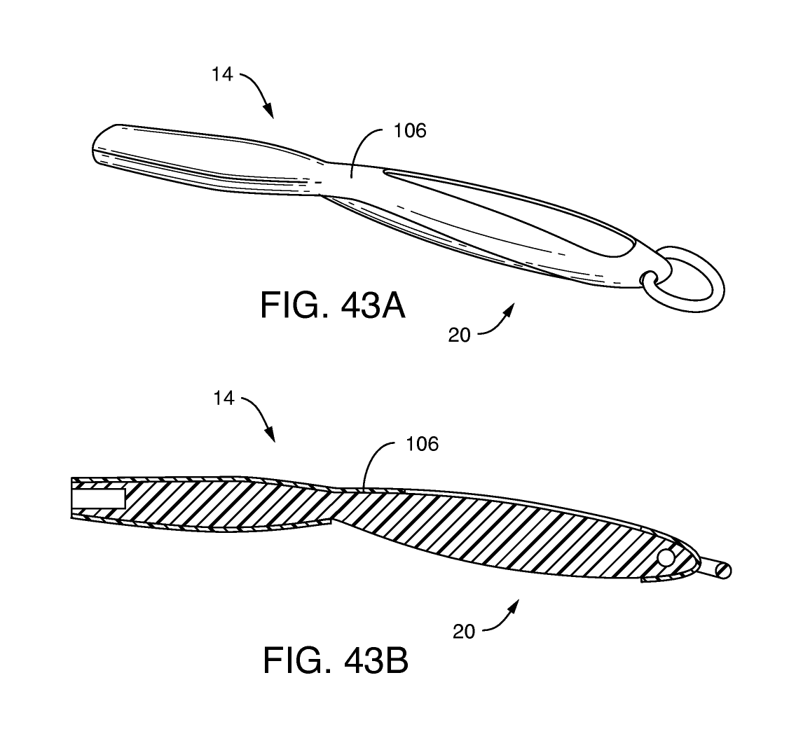

FIGS. 40-43B depict various alternative handles 14. FIG. 40 depicts a different configuration for a wrist lanyard 42 that is attached through a flat wood handle 14 through aperture 40. FIG. 41 depicts a handle 14 with a soap dispensing trigger 63. FIGS. 42A and 42B depict a solid, molded handle 14. FIGS. 43A and 43B depict a solid, molded handle 14 with an overmold 106.

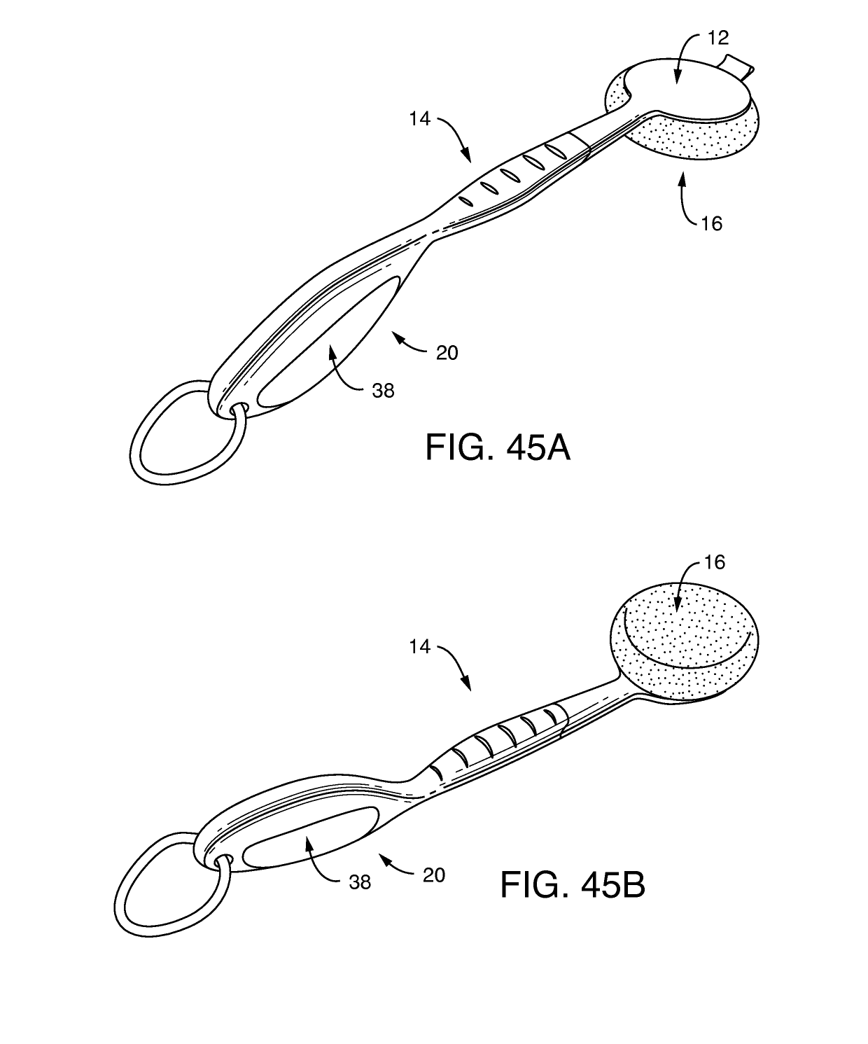

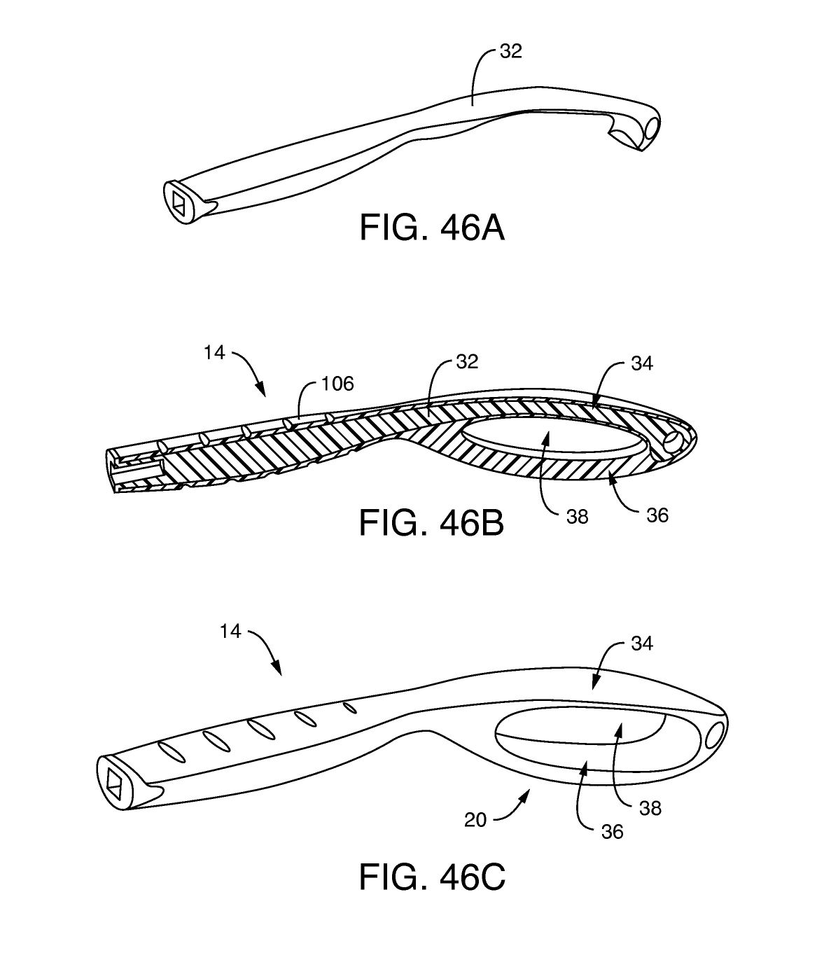

FIGS. 45A and 45B depict an alternative shape of a handle 14. FIG. 46A depicts a solid rigid substrate 32 for handle 14. FIG. 46B depicts a cross-sectional view of the substrate 32 of FIG. 46A covered by an overmold 106 forming grasp 20 including a first section 34 and a second section 36 forming loop hole 38. FIG. 46C depicts a perspective view of the handle 14 of FIG. 46B.

### EMBODIMENTS

### Embodiment 1

A bathing wand comprising: a handle including a grasp, the grasp including a first section and a second section, the first section and the second section forming a loop hole configured to receive a user's hand; a wand head; and a bathing implement, the bathing implement being coupled to the wand head.

### Embodiment 2

The bathing wand of embodiment 1, wherein the loop hole comprises a length of at least about 80 millimeters and the loop hole comprises a height of at least about 15 millimeters.

### Embodiment 3

The bathing wand of any one of the preceding embodiments, wherein a height of the grasp defined by an outer surface of the first section and an outer surface of the second section is between about 30 millimeters and about 70 millimeters.

### Embodiment 4

The bathing wand of any one of the preceding embodiments, wherein the first section of the grasp provides a rigid section and the second section of the grasp provides a pliable section.

### Embodiment 5

The bathing wand of embodiment 4, wherein the pliable section is on a bottom side of the bathing wand.

### Embodiment 6

The bathing wand of any one of the preceding embodiments, wherein the grasp includes an overmold, the first section of the grasp being covered by the overmold and the overmold forming the entire second section of the grasp.

### Embodiment 7

A bathing wand comprising: a handle comprising an arm, the arm including a vertebrae system including a plurality of links coupled together, the vertebrae system allowing the arm to bend; a wand head; and a bathing implement, the bathing implement being coupled to the wand head.

### Embodiment 8

The bathing wand of embodiment 7, wherein the arm further includes a spine disposed in a channel in the vertebrae system.

### Embodiment 9

The bathing wand of embodiment 7 or embodiment 8, wherein the arm includes an overmold and the vertebrae system is disposed internal to the overmold.

### Embodiment 10

The bathing wand of any one of embodiments 7-9, wherein the vertebrae system includes a proximal link, a distal link, and at least one mid-link, the proximal link being coupled to a handle substrate near a first end of the arm and the distal link being coupled to a neck of the arm near a second end of the arm.

### Embodiment 11

The bathing wand of any one of embodiments 7-10, wherein the vertebrae system is configured to allow the arm to bend through a bending zone, the bending zone being between about 0° and about 90° of rotation of the arm.

### Embodiment 12

A bathing wand comprising: a handle including an arm, the handle further including a grasp on a first end of the arm and a neck on a second end of the arm, the neck including one of a raised feature and an aperture; a wand head, the wand head including a receiver configured to be removably coupled to the handle by the receiver receiving the neck of the handle, the receiver including the other of a raised feature and an aperture, the raised feature configured to fit in the aperture to removably couple the wand head to the handle; a bathing implement, the bathing implement being coupled to the wand head.

### Embodiment 13

The bathing wand of embodiment 12, wherein the neck includes the raised feature and the receiver includes the aperture.

### Embodiment 14

The bathing wand of embodiment 12 or embodiment 13, wherein the neck includes a stem, the stem being a narrowed end of the neck, the stem including the raised feature.

### Embodiment 15

The bathing wand of any one of embodiments 12-14, wherein the wand head further includes a domed section, the domed section including the aperture.

### Embodiment 16

The bathing wand of embodiment 12, wherein the wand head further includes a skirt, the skirt substantially surrounding the domed section and being coupled to the bathing implement.

### Embodiment 17

The bathing wand of embodiment 16, wherein the skirt includes an undulating outer edge including a plurality of valleys.

### Embodiment 18

The bathing wand of any one of embodiments 12-17, wherein the wand head further includes a strap coupled to a top surface of the wand head.

### Embodiment 19

The bathing wand of any one of embodiments 12-18, wherein the grasp forms a loop hole configured to receive a user's hand.

### Embodiment 20

The bathing wand of any one of the preceding embodiments, wherein the bathing implement is coupled to the wand head with an adhesive, wherein the wand head comprises a polymer and the adhesive comprises the polymer.

### Embodiment 21

The bathing wand of embodiment 20, wherein the polymer is an ethylene vinyl acetate copolymer.

### Embodiment 22

The bathing wand of embodiment 21, wherein the ethylene vinyl acetate copolymer comprises about 20% by weight of the wand head.

When introducing elements of the present disclosure or the preferred embodiment(s) thereof, the articles “a”, “an”, “the” and “said” are intended to mean that there are one or more of the elements.

The terms “comprising”, “including” and “having” are intended to be inclusive and mean that there may be additional elements other than the listed elements. Many modifications and variations of the present disclosure can be made without departing from the spirit and scope thereof. Therefore, the exemplary embodiments described above should not be used to limit the scope of the invention.

1. A bathing wand comprising:
a handle including a grasp, the grasp including a first section and a second section, the first section and the second section forming a loop hole configured to receive a user's hand;
a wand head; and
a bathing implement, the bathing implement being coupled to the wand head.

2. The bathing wand of claim 1, wherein the loop hole comprises a length of at least about 80 millimeters and the loop hole comprises a height of at least about 15 millimeters.

3. The bathing wand of claim 1, wherein a height of the grasp defined by an outer surface of the first section and an outer surface of the second section is between about 30 millimeters and about 70 millimeters.

4. The bathing wand of claim 1, wherein the first section of the grasp provides a rigid section and the second section of the grasp provides a pliable section.

5. The bathing wand of claim 4, wherein the pliable section is on a bottom side of the bathing wand.

6. The bathing wand of claim 1, wherein the grasp includes an overmold, the first section of the grasp being covered by the overmold and the overmold forming the entire second section of the grasp.

7. A bathing wand comprising:
a handle comprising an arm, the arm including a vertebrae system including a plurality of links coupled together, the vertebrae system allowing the arm to bend;
a wand head; and
a bathing implement, the bathing implement being coupled to the wand head.

8. The bathing wand of claim 7, wherein the arm further includes a spine disposed in a channel in the vertebrae system.

9. The bathing wand of claim 7, wherein the arm includes an overmold and the vertebrae system is disposed internal to the overmold.

10. The bathing wand of claim 9, wherein the vertebrae system includes a proximal link, a distal link, and at least one mid-link, the proximal link being coupled to a handle substrate near a first end of the arm and the distal link being coupled to a neck of the arm near a second end of the arm.

11. The bathing wand of claim 7, wherein the vertebrae system is configured to allow the arm to bend through a bending zone, the bending zone being between about 0° and about 90° of rotation of the arm.

12. A bathing wand comprising:
a handle including an arm, the handle further including a grasp on a first end of the arm and a neck on a second end of the arm, the neck including one of a raised feature and an aperture;
a wand head, the wand head including a receiver configured to be removably coupled to the handle by the receiver receiving the neck of the handle, the receiver including the other of a raised feature and an aperture, the raised feature configured to fit in the aperture to removably couple the wand head to the handle;
a bathing implement, the bathing implement being coupled to the wand head.

13. The bathing wand of claim 12, wherein the neck includes the raised feature and the receiver includes the aperture.

14. The bathing wand of claim 12, wherein the neck includes a stem, the stem being a narrowed end of the neck, the stem including the raised feature.

15. The bathing wand of claim 12, wherein the wand head further includes a domed section, the domed section including the aperture.

16. The bathing wand of claim 15, wherein the wand head further includes a skirt, the skirt substantially surrounding the domed section and being coupled to the bathing implement.

17. The bathing wand of claim 16, wherein the skirt includes an undulating outer edge including a plurality of valleys.

18. The bathing wand of claim 12, wherein the wand head further includes a strap coupled to a top surface of the wand head.

19. The bathing wand of claim 12, wherein the grasp forms a loop hole configured to receive a user's hand.

20. The bathing wand of claim 12, wherein the bathing implement is coupled to the wand head with an adhesive, wherein the wand head comprises a polymer and the adhesive comprises the polymer.

21. The bathing wand of claim 20, wherein the polymer is an ethylene vinyl acetate copolymer.

22. The bathing wand of claim 21, wherein the ethylene vinyl acetate copolymer comprises about 20% by weight of the wand head.
